(19) United States
(12) Patent Application Publication
(10) Pub. No.: US 2026/0290319 A1
(43) Pub. Date: Sep. 24, 2026

(54) SYSTEM

(71) Applicant: SoftBank Group Corp., Tokyo (JP)

(72) Inventor: Takeshi OGAWA, Tokyo (JP)

(73) Assignee: SoftBank Group Corp., Tokyo (JP)

(21) Appl. No.: 19/567,019

(22) Filed: Mar. 14, 2026

(30) Foreign Application Priority Data
Mar. 19, 2025 (JP) 2025-045179

(51) Int. Cl. G10L 13/10; G06Q 30/015; G06T 13/20; G06V 10/44; G06V 40/16; G10L 15/183

(52) U.S. Cl. CPC G10L 13/10; G06Q 30/015; G06T 13/205; G06V 10/454; G06V 40/174; G10L 15/183

(57) ABSTRACT

A system includes a processor that is configured to receive an input from a user and generate, based on the input, a prompt sentence that instructs a generative AI model to perform a specific sales activity, input the generated prompt sentence into the generative AI model to generate a sales talk, and convert the generated sales talk into audio data by using a speech synthesis technique and transmit the audio data to a terminal of the user.

### CROSS-REFERENCE TO RELATED APPLICATION

This application is based on and claims priority under 35 USC 119 from Japanese Patent Application No. 2025-045179 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional sales activities that rely on human salespersons suffer from several inherent problems. First, the quality of sales talks, including persuasiveness, clarity, and consistency, varies significantly depending on the individual salesperson's skills, experience, and daily condition. Second, maintaining high motivation and performance among human salespersons requires continuous management, supervision, and often high compensation, which leads to increased operational costs. Third, it is difficult to provide human-like, real-time, and scalable customer engagement, particularly in remote or online environments, without deploying a large number of trained staff. Furthermore, when using conventional automated systems or simple scripted chatbots, the generated responses are often rigid, unnatural, and unable to flexibly perform specific sales activities in accordance with the user's intent. Accordingly, there is a need for a system that can automatically generate and deliver persuasive, human-like sales talks based on a user's input, while reducing dependence on human salespersons, ensuring consistency in sales activities, and avoiding the management and compensation burdens associated with maintaining human motivation.

### SUMMARY

To solve the above problems, the present invention provides a system comprising a processor, wherein the processor is configured to receive an input from a user and generate, based on the input, a prompt sentence that instructs a generative AI model to perform a specific sales activity. The processor is further configured to input the generated prompt sentence into the generative AI model to generate a sales talk, and to convert the generated sales talk into audio data by using a speech synthesis technique and transmit the audio data to a terminal of the user. In addition, the processor is configured to provide, through a user interface, visually and aurally human-like responses for customer interaction by anthropomorphizing the generative AI model, thereby enabling the generative AI model to act as a human-like sales agent. Furthermore, the processor is configured to provide an automated sales process by using the generative AI model so as to eliminate variations in motivation and ability of human salespersons in sales activities and to avoid a need for management or high compensation required to maintain motivation. By these means, the system achieves consistent, scalable, and cost-effective sales activities while delivering natural, persuasive customer interactions.

The term “system” refers to an arrangement including at least one processor and, where appropriate, associated memory, communication interfaces, and input/output components configured to execute the functions described in the claims.

The term “processor” refers to one or more hardware processing units, such as a central processing unit (CPU), graphics processing unit (GPU), or specialized AI accelerator, capable of executing instructions stored in memory to perform operations defined by software or firmware.

The term “user” refers to a human operator, such as a sales manager, system administrator, or other authorized person, who provides inputs to the system and/or receives outputs from the system.

The term “input” refers to information, including but not limited to text, parameters, settings, or commands, that is provided by the user to the system for the purpose of specifying a desired sales activity or operation to be performed by the system.

The term “prompt sentence” refers to a text string or structured textual instruction generated by the processor, based on the user's input, that is designed to be supplied to the generative AI model so as to cause the model to perform a specific sales activity or generate a particular type of sales talk.

The term “generative AI model” refers to a machine learning model, such as a large language model or a multimodal generative model, that is configured to produce output content, including text, in response to a given prompt or input.

The term “sales activity” refers to an action or sequence of actions related to sales, including but not limited to initiating customer contact, explaining products or services, handling objections, proposing offers, and attempting to close deals.

The term “sales talk” refers to a sequence of one or more utterances, typically in natural language, generated by the generative AI model in response to the prompt sentence, and intended to perform or support a sales activity directed to a customer or prospective customer.

The term “speech synthesis technique” refers to a method, implemented in hardware or software, for converting text data, such as the sales talk, into corresponding audio data representing spoken speech.

The term “audio data” refers to digital data representing sound, including synthesized speech corresponding to the generated sales talk, which is suitable for playback on an audio output device.

The term “terminal” refers to an electronic device operated by or accessible to the user, such as a personal computer, smartphone, tablet, or dedicated client device, that is configured to send inputs to the system and receive outputs, including audio data, from the system.

The term “user interface” refers to a software-implemented interface, including graphical, voice-based, or other interaction modalities, presented on the terminal or another device, through which the system provides information to and receives information from the user or a customer.

The term “anthropomorphizing” refers to processing by which the generative AI model and its outputs are presented in a manner that imitates human-like behavior or characteristics, including facial expressions, gestures, voice qualities, conversational style, or persona attributes, so that interactions appear similar to interactions with a human.

The term “visually and aurally human-like responses” refers to responses produced by the system that appear human-like when perceived visually, such as by displaying an avatar or animation, and aurally, such as by using natural-sounding synthesized speech, intonation, and timing.

The term “customer interaction” refers to communication between the system and an end customer or prospective customer, including but not limited to answering questions, presenting offers, explaining products, and conducting sales conversations.

The term “automated sales process” refers to a series of sales-related operations that are performed by the system without requiring direct, real-time manual control by a human salesperson, including generation of sales talk, presentation to the customer, and handling of at least part of the interaction flow.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

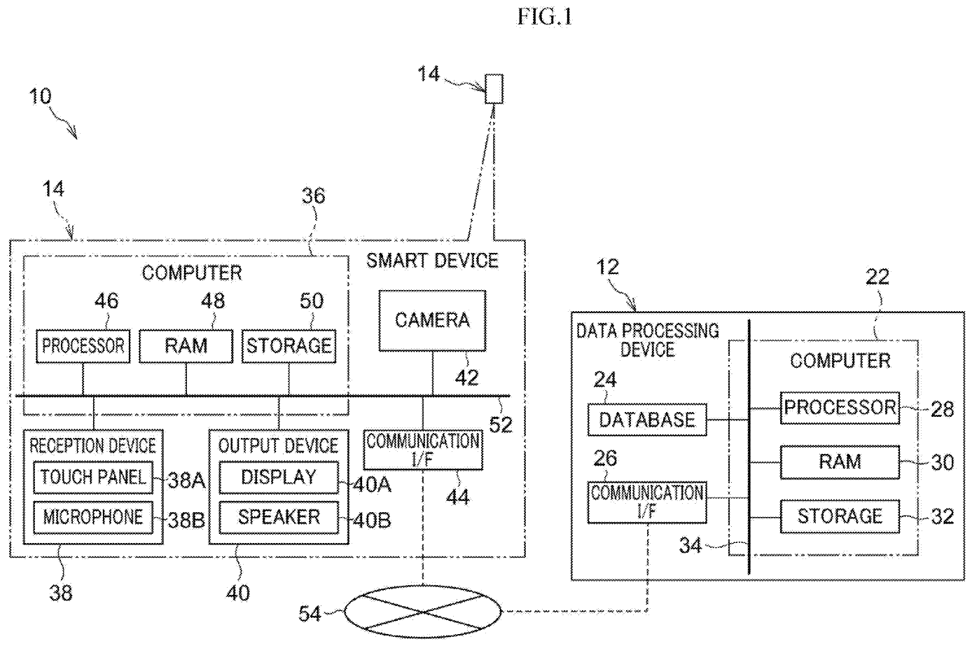

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

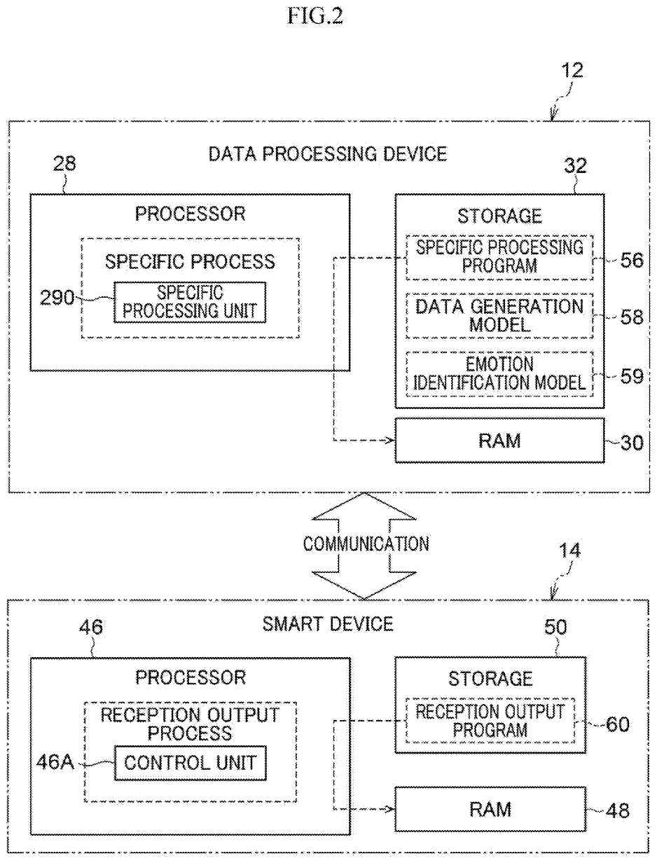

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented sales support systems primarily focus on static script management, template-based recommendation, or simple rule-based dialogue. Such systems typically treat speech content, prosody, and non-verbal behavior, such as facial expressions, as separate or non-modeled elements. As a result, these systems fail to capture and reproduce the combined verbal and non-verbal patterns that make human sales representatives effective, and they cannot consistently generate adaptive, high-quality sales talk that reflects both linguistic intent and expressive style.

Furthermore, known dialogue systems often rely on generic language models or fixed prompts that are not trained on aligned multimodal data linking actual spoken sales talk to corresponding facial expression states. Without explicit alignment between textual content and expression features, the underlying models cannot learn how specific expression states, such as confidence, friendliness, or enthusiasm, are coordinated with particular sales phrases, timing, or emphasis. This leads to generated content that is linguistically acceptable but lacks the behavioral nuance and persuasive impact required in real sales interactions.

In addition, existing systems for anthropomorphized conversational agents typically render animated characters or avatars that are driven by pre-scripted behaviors or manually designed expression rules. These approaches require significant manual effort to design and maintain, do not scale well across products, markets, or languages, and are unable to adapt based on large volumes of real-world sales performance data. Consequently, such systems do not improve the core computational mechanisms for generating human-like, context-specific, and expression-aware sales talk.

Moreover, there is a technical problem in standardizing the quality and style of sales communication across an organization. Sales performance often depends on the individual ability, experience, and motivation of human sales personnel, resulting in inconsistent outcomes and requiring continuous human training, monitoring, and incentive schemes. Existing sales support tools do not provide a truly automated, system-level mechanism that uses learned patterns of speech and expressions to deliver consistent, high-level performance while reducing dependency on human variability.

From a computer-technology perspective, there is a need for an improved architecture and processing pipeline that: (i) acquires and preprocesses audio and image information from real sales activities; (ii) generates and aligns character information and facial-expression feature information at the computing-system level; (iii) trains a generative AI model based on this aligned multimodal data; and (iv) uses prompt sentences with explicit conditions to generate and synthesize sales talk in a standardized, controllable manner. Such an architecture should enhance the technical performance of the generative system itself, including more accurate conditioning on style and expression, more efficient reuse of multimodal training data, and more consistent output behavior in response to user instructions.

Accordingly, an object of the present invention is to provide a computer-implemented system and associated processing configuration that implement a technically improved pipeline for: automatically learning correlations between textual sales content and facial expression states; constructing a generative AI model that can generate sales talk conditioned on sales conditions, target customer attributes, speaking style, and facial expressions; and delivering an anthropomorphized, multimodal response through a user interface. Another object is to provide a system that technically standardizes and automates sales processes by leveraging such a generative AI model, thereby reducing reliance on manual script creation, rule design, and human-driven variation, and improving the consistency, scalability, and effectiveness of computer-based sales support.

The specific processing by the specific processing unit 290 of the data processing device 12 in Example 1 is realized by the following means.

The present invention provides a server comprising a processor configured to acquire sales-related audio information and image information, generate character information indicating speech content of a speaker from the audio information, generate feature information indicating a facial expression state of the speaker from the image information, and store the character information and the feature information in association with each other; to train a generative AI model using the character information and the feature information by applying a generative artificial intelligence technique, and construct the generative AI model so as to be capable of generating sales talk conditioned on speech patterns and facial expression states in sales activities; to receive, from a user, a prompt sentence including instructions regarding sales conditions, target customer attributes, speaking style, and facial expression state, and configure input information supplied to the generative AI model based on the prompt sentence; to input the prompt sentence to the generative AI model and generate, by the generative AI model, sales talk corresponding to the sales conditions, the target customer attributes, the speaking style, and the facial expression state included in the prompt sentence; to convert the generated sales talk into audio information by using a speech synthesis technique and transmit the audio information to a user terminal; and to control a user interface provided on the user terminal so as to display the character information of the generated sales talk, to present a visual response based on the feature information regarding the facial expression state associated with the generated sales talk, and to receive a user operation including reproduction control. This enables the computing system to learn and exploit aligned multimodal patterns of speech and facial expressions, to technically improve the conditioning and output behavior of the generative AI model, and to provide an automated, standardized, and anthropomorphized sales process that reduces dependence on human variability while enhancing the consistency and effectiveness of computer-implemented sales interactions.

The term “audio information” refers to information represented as time-varying acoustic signals, including digital or analog representations of sound, such as voice recordings of speech produced during sales activities.

The term “image information” refers to information representing visual scenes, including still images and moving images obtained from an imaging device, such as video frames capturing a speaker during sales activities.

The term “character information” refers to text-based information that encodes linguistic content, including characters, symbols, or strings representing the speech content transcribed from audio information.

The term “feature information” refers to structured data derived from analysis of raw media, including numerical values, labels, or vectors that characterize a state or attribute, such as a facial expression state extracted from image information.

The term “facial expression state” refers to a condition of a person's face, including configurations of facial muscles and features, such as mouth, eyes, and eyebrows, that correspond to emotional or attitudinal cues like smiling, neutrality, confidence, or surprise.

The term “sales talk” refers to a sequence of utterances or textual content intended to promote goods or services, including explanatory, persuasive, and closing statements used in commercial or business-related interactions.

The term “speech patterns” refers to characteristic properties of spoken language, including word choice, phrase structure, rhythm, emphasis, and prosody, as exhibited in sales talk during sales activities.

The term “sales activities” refers to operations related to promoting, explaining, or offering goods or services to potential or existing customers, including presentations, demonstrations, negotiations, and follow-up communications.

The term “generative AI model” refers to a computational model based on artificial intelligence techniques that is configured to generate new data, such as text, in response to input conditions, including models implemented with machine learning or deep learning architectures.

The term “generative artificial intelligence technique” refers to a processing technique that uses trained machine learning or deep learning models to produce new outputs, such as generated text, conditioned on input data or parameters.

The term “prompt sentence” refers to a textual input provided to the generative AI model that specifies conditions, instructions, or context, including sales conditions, target customer attributes, speaking style, or desired facial expression state.

The term “sales conditions” refers to parameters related to a sales scenario, including product type, pricing, campaign details, usage environment, or constraints under which goods or services are offered.

The term “target customer attributes” refers to information describing characteristics of intended customers, including demographic, industry, role, needs, or behavioral profiles.

The term “speaking style” refers to a manner in which speech is delivered, including tone, formality level, enthusiasm, confidence, politeness, brevity, or other stylistic aspects.

The term “user interface” refers to a functional component that enables interaction between a user and the system, including visual, auditory, and input elements that display information and receive user operations.

The term “user operation” refers to an action performed by a user through the user interface, including inputting text, selecting options, initiating or stopping playback, or modifying parameters.

The term “reproduction control” refers to control commands related to playback of audio or visual content, including play, pause, stop, seek, volume adjustment, or repetition.

The term “speech synthesis technique” refers to a processing technique that converts text or symbolic representation of speech into audio information, including rule-based synthesis, concatenative synthesis, and neural network-based text-to-speech synthesis.

The term “user terminal” refers to an electronic apparatus operated by a user to interact with the system, including a portable terminal, a stationary terminal, a display device, or a communication device.

The term “visual response” refers to output information presented in a visual form through the user interface, including images, animations, avatars, or graphical indicators that reflect the generated sales talk or associated expression states.

The term “auditory response” refers to output information presented as sound, including synthesized speech or audio signals representing the generated sales talk.

The term “human-like figure” refers to a visual representation that resembles a person, including a static image, animated character, avatar, or graphical body that can be used to simulate human appearance or behavior.

The term “anthropomorphizing” refers to a process of presenting a non-human system, such as a generative AI model, in a manner that imitates human-like characteristics, including visual appearance, speech behavior, and interactive responses.

The term “automated sales process” refers to a sequence of operations related to sales activities that is executed by a computing system without requiring direct manual generation of each sales utterance, including generation, presentation, and control of sales talk based on learned models.

In one embodiment, a server, a terminal, and a user cooperate to implement the invention. The server is realized by an information processing apparatus including at least one processor, a memory, a nonvolatile storage device, and a communication interface. The server is connected via a communication network to one or more terminals. Each terminal is realized by an electronic apparatus such as a portable communication device, a tablet, or a personal computer, including at least a processor, a display unit, an audio output unit, an input unit, and a network interface. The user operates the terminal to interact with the server.

The server executes a program stored in the nonvolatile storage device and loaded into the memory. The program is implemented, for example, using an operating system such as a general-purpose server operating system, a programming language runtime such as a high-level language interpreter or compiler, and application libraries such as a numerical computation library, a machine learning framework, and a multimedia processing library. The machine learning framework may be, for instance, a deep learning framework executing on a graphics processing unit, and the multimedia processing library may include an image processing library and an audio processing library.

The server generates and maintains a data structure storing multimodal sales activity data. The server stores, in the storage device, audio information representing speech of human sales representatives, and image information representing visual scenes including faces of the representatives. The server stores the audio information and image information as files in a file system, for example in a hierarchical directory structure. The server further stores, in a database management system, metadata entries including unique identifiers for each audio file and image file, timestamps, speaker identifiers, product categories, and customer attributes. The server thus maintains a relational association between media data and contextual attributes, enabling efficient retrieval and indexing. This structured storage with identifiers and indexes improves data management performance and enables scalable access compared to unstructured storage of media files.

The server uses the processor to execute audio processing software that loads the audio information from the file system into memory. The server transforms the raw audio waveforms into a digital representation suitable for speech recognition by applying discrete Fourier transforms, band-pass filtering, and noise reduction algorithms such as spectral subtraction and statistical noise estimation. The server determines a sampling rate and bit depth appropriate for speech recognition and normalizes amplitude levels. By performing these signal-processing operations, the server reduces background noise and dynamic range variation, thereby improving the accuracy of subsequent speech recognition and enabling more reliable generation of character information.

The server uses a speech recognition engine that may be implemented by a neural network-based acoustic model and a language model running on the processor and, optionally, on a graphics processing unit. The acoustic model may be realized by a deep neural network architecture such as a convolutional-recurrent network or a transformer-based encoder that operates on acoustic feature vectors (for example, Mel-frequency cepstral coefficients). The server computes these feature vectors from the audio information and feeds them into the acoustic model. The server decodes the model output using a beam search algorithm combined with a statistical language model or a neural language model to produce a sequence of characters or tokens. The server thereby generates character information indicating the speech content of the sales representative. The server stores, in the database, the character information as text strings associated with corresponding audio identifiers and timestamps. By using the neural acoustic model and beam search, the server achieves improved recognition accuracy and robustness compared to simple template matching, and reduces transcription errors that would propagate into later generative modeling.

The server uses the processor to execute image processing software that loads the image information from the file system. The server interprets the image information as sequences of frames (for example, decoded video frames). The server applies a face detection algorithm, such as a convolutional neural network-based detector, to each frame or to frames sampled at predefined intervals. The server identifies bounding boxes including human faces and then uses a facial landmark detection model, which may be a deep regression model, to compute coordinates of key points such as eyes, nose, and mouth corners. The server normalizes the face images by aligning them based on the landmarks and resizing them to a standard resolution.

The server extracts feature information indicating facial expression states by applying a facial expression recognition model to the normalized face images or to temporal sequences of face images. This model may be a convolutional neural network, a recurrent neural network, a transformer-based vision encoder, or a combination thereof. The server computes a feature vector for each frame or time segment and classifies it into categories such as “smile,” “neutral,” “serious,” “surprised,” “confident,” and the like, or predicts continuous expression scores such as valence and arousal. The server stores, in the database, feature information entries including timestamps, expression labels, and numerical intensity values. The server associates these entries with the corresponding image file identifiers and speaker identifiers.

The server aligns the character information with the feature information by using time-based data structures. The server stores, for each audio file, a mapping between time indices and character positions obtained from the speech recognition engine, and stores, for each video file, a mapping between time indices and expression labels obtained from the facial expression recognition model. The server uses the processor to compute, for each sentence or phrase in the character information, a corresponding time interval and determines the predominant expression labels and intensity values within that interval. The server then stores aligned segment entries containing a text segment, associated expression labels, average intensities, and contextual attributes such as product category and customer type.

By explicitly storing this alignment in structured records, the server creates training samples that jointly encode linguistic content and facial expression states. This specific data structure, with synchronized text-expression pairs and contextual tags, enables the later generative AI model to learn correlations not only between words and sequences, but also between sales strategies and nonverbal cues. This improves the model's ability to condition on style and expression beyond what is possible in text-only models, thereby enhancing technical performance in generating multimodal-consistent outputs.

The server uses the processor to construct and train a generative AI model that is capable of generating sales talk conditioned on the aligned multimodal data. In one embodiment, the generative AI model is implemented as a transformer-based neural network with multiple self-attention layers, feedforward layers, and normalization layers. The server defines an input sequence format in which tokens representing the prompt sentence, tokens indicating sales conditions and target customer attributes, and special tokens representing speaking style and facial expression states are concatenated into a single sequence. The server maps each token to an embedding vector by using an embedding matrix stored in memory. The server also embeds expression features and contextual attributes by projecting them into the same vector space and concatenating or adding them to the token embeddings.

The server trains the generative AI model by using a training dataset derived from the aligned segment entries. The server divides the dataset into mini-batches, uses the processor and the graphics processing unit to perform forward passes of the transformer network on each mini-batch, and computes a loss function such as cross-entropy between the predicted token probabilities and the ground-truth tokens representing sales talk. The server applies an optimization algorithm such as Adam or AdamW to update the model parameters based on gradients computed by backpropagation. The server may perform regularization such as dropout, label smoothing, and data augmentation (for example, random masking of tokens, random permutation of similar expression tags) to improve generalization. The server periodically evaluates the model on validation data and stores checkpoints of the model parameters in the storage device.

Because the generative AI model is trained on data that explicitly couples linguistic content with expression states and contextual conditions, the model internalizes high-dimensional patterns that human designers cannot feasibly encode as simple business rules. The server thus enables improved generation accuracy, better style control, and more stable behavior under varying prompt conditions. From a computer technology standpoint, this architecture improves the efficiency of using multimodal training data and reduces the need for manual feature engineering.

The user operates the terminal to input a prompt sentence. The terminal executes an application program that displays an input field. The user can enter a natural-language instruction such as:
“Generate a concise, confident sales talk for a new cloud-based accounting system targeted at small business owners. Emphasize time savings and ease of use.”

The user can also enter other prompt sentences, for example:
“Create a short, energetic sales talk that highlights the unique camera features of a new smartphone for general consumers, focusing on night photography and ease of use.”
“Generate a cross-selling sales talk for an existing customer who already uses a cloud storage service, proposing a new backup and disaster recovery solution in a professional and reassuring tone.”

The terminal uses the processor to encode the prompt sentence in a structured request, adding optional fields such as desired length, language, or tone. The terminal sends this request to the server through the network interface using a communication protocol such as HTTPS. The request includes the prompt sentence as textual data.

The server receives the prompt sentence, uses the same tokenizer and embedding mechanism as in training, and constructs input information for the trained generative AI model. The server maps terms such as “confident” or “energetic” to internal style tags that correspond to combinations of expression feature vectors and prosodic patterns learned during training. Unlike manual rule-based systems, the server uses such learned mappings that have been optimized via gradient-based learning, leading to more nuanced and consistent responses.

The server executes an inference procedure of the generative AI model. The server supplies the embedded prompt sequence and style-expression tokens to the transformer network and performs a forward pass to compute probability distributions over possible next tokens at each decoding step. The server applies a decoding strategy such as beam search with constraints on maximum length and repetition penalties, or sampling with top-k or nucleus sampling, to generate a sequence of tokens representing the sales talk. The server decodes the token sequence into a text string and optionally performs post-processing such as sentence boundary checking and removal of incomplete fragments. The server stores and returns the generated sales talk as character information.

The server transmits the generated character information to the terminal together with additional information such as suggested expression states and timing cues based on internal style tags. The terminal displays the generated sales talk in a text area on the display unit so that the user can review and optionally edit the text. The terminal provides controls such as buttons or sliders for playback, volume, and voice selection.

The terminal converts the generated sales talk into audio information by using a speech synthesis technique. In one embodiment, the terminal invokes a text-to-speech engine provided by the operating system or by a network-based service. The terminal supplies the text string and parameters indicating speaking style, rate, pitch, and emphasis. The text-to-speech engine converts the text into phoneme sequences, computes prosodic features, and generates a waveform by using a synthesis model such as a neural vocoder. The terminal outputs the synthesized audio through the audio output unit such as a built-in speaker or a connected headset. The user can therefore present the generated sales talk as natural-sounding speech to a customer.

The terminal may also display a human-like figure synchronized with the audio output. The server, based on expression tags associated with the style definition, sends instructions for facial expression patterns and timing to the terminal. The terminal uses these instructions to control an animated avatar or graphical element whose mouth movements and facial expressions correspond to the synthesized speech and the designated expression states. In this way, the server and terminal together present an anthropomorphized response. Because the facial behavior is driven by learned expression features rather than hard-coded animation scripts, the system can flexibly adapt to new styles and languages without redesigning animation rules, thereby improving scalability and reducing manual configuration.

In alternative embodiments, the server may perform a portion of the speech synthesis processing and transmit pre-synthesized audio to the terminal, for example when the terminal has limited computing resources. Conversely, the server may allow on-device inference of a smaller generative AI model on the terminal for low-latency scenarios, using compressed model parameters and quantized weights to reduce memory and computation cost. Different hardware configurations can be selected according to performance requirements and network conditions.

The server implements specific data structures and processing sequences that provide technical advantages. By pre-aligning text segments with expression states and contextual attributes into structured records, the server reduces the search space during model training and inference, which results in faster convergence, lower memory usage, and reduced communication overhead between storage and compute components. By embedding expression features into the same latent space as linguistic tokens, the server enables efficient joint conditioning without the need for multiple separate models, thereby improving inference speed and resource utilization.

The server improves computer technology by enabling more accurate and controllable generation of multimodal sales talk than could be achieved with generic, text-only language models. The use of specific neural network architectures and training procedures tailored to aligned multimodal data leads to lower error rates in matching desired styles and conditions, and reduces the frequency of inappropriate or mismatched outputs. The system further improves data management by organizing multimodal sales data in a relational manner with explicit alignment, enabling efficient querying and updating as new data are collected.

The user benefits from this improved computer-implemented system by being able to generate, via the terminal, sales talk that is consistent in quality and style and that reflects human-like verbal and non-verbal patterns derived from large-scale real interactions. However, the primary improvement lies not in the automation of business tasks as such, but in the optimization of the internal computational processes: the server uses learned multimodal correlations, specialized network architectures, and structured data flows to achieve higher performance, precision, and efficiency than conventional systems.

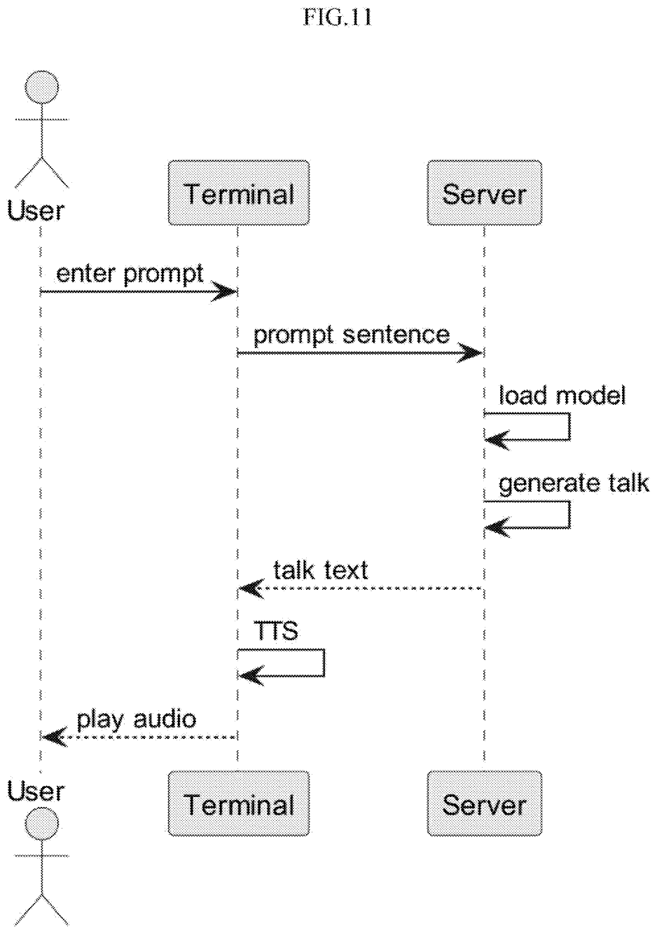

The following describes the processing flow using FIG. 11.

### Step 1

Server acquires and stores raw multimodal sales data.

Server receives, as input, audio files containing recorded sales talk and video files containing corresponding sales scenes, together with metadata such as salesperson identifier, product category, and recording time. Server uses a storage interface to write the audio and video files into a file system and inserts metadata records into a database, associating each file with a unique identifier. Server thereby outputs structured storage entries that map each recording to its file paths and contextual attributes.

### Step 2

Server preprocesses audio information and generates character information.

Server reads, as input, the audio files referenced in the metadata. Server converts the audio into digital waveforms, applies band-pass filtering and noise reduction (for example, spectral subtraction), and normalizes amplitude. Server then computes acoustic features such as Mel-frequency cepstral coefficients and feeds these features into a speech recognition engine. Based on probabilistic decoding (for example, beam search over an acoustic and language model), server outputs character information in the form of text transcripts aligned with time indices, and stores these transcripts in the database linked to the original audio identifiers.

### Step 3

Server preprocesses image information and generates facial-expression feature information.

Server reads, as input, the video files and decodes them into sequences of frames. Server applies a face-detection algorithm to each frame or to sampled frames, then performs facial landmark detection to identify key points such as eyes and mouth. Server crops and normalizes face regions and feeds these regions or temporal sequences of regions into an expression-recognition model. Server computes, from this model, expression labels and intensity values for each time index and outputs feature information describing facial expression states over time, storing this information in the database associated with the corresponding video identifiers.

### Step 4

Server aligns character information with facial-expression feature information.

Server retrieves, as input, the time-aligned character information from audio processing and the time-indexed facial-expression feature information from video processing. Server segments the character information into phrases or sentences based on punctuation and detected pauses, and for each segment server determines a corresponding time interval. Server then aggregates facial-expression labels and intensities within each interval and selects predominant expressions. Server outputs aligned segment records that contain text segments, dominant expression labels, average intensities, and contextual attributes, and stores these records as training samples.

### Step 5

Server constructs structured training data for the generative AI model.

Server takes, as input, the aligned segment records containing text segments, expression labels, and contextual attributes. Server converts the text segments into token sequences using a tokenizer, maps expression labels and contextual attributes into categorical or numerical feature codes, and encapsulates them in a standardized training example format. Server outputs a training dataset in which each example includes conditional information (such as product type, customer profile, speaking style, and facial-expression state) and target sales-talk tokens, and stores this dataset as one or more files for model training.

### Step 6

Server trains the generative AI model using the structured training data.

Server loads, as input, the training dataset and an initial neural network configuration for the generative AI model, such as a transformer-based architecture with embedding layers, self-attention layers, and feedforward layers. Server converts each training example into numerical tensors: token IDs for the text and embedding vectors for style and expression features. Server performs forward propagation to compute predicted token distributions, calculates a loss function such as cross-entropy between predicted and actual tokens, and performs backpropagation to compute gradients with respect to model parameters. Server updates the parameters using an optimization algorithm and repeats this process over the dataset for multiple epochs. Server outputs a trained generative AI model with learned weights, which is stored in nonvolatile memory for later inference.

### Step 7

User composes a prompt sentence on the terminal.

User provides, as input, natural-language instructions describing a desired sales scenario, such as “Generate a concise, confident sales talk for a new cloud-based accounting system targeted at small business owners. Emphasize time savings and ease of use.” User operates the input interface on the terminal to type this prompt sentence and selects optional settings such as language or tone. User triggers a generation request, and the terminal outputs the prompt sentence and settings as data ready to be transmitted to the server.

### Step 8

Terminal sends the prompt sentence and parameters to the server.

Terminal receives, as input, the user-entered prompt sentence and any selected options. Terminal formats these into a request message including fields such as prompt text, desired style, and length constraints. Terminal uses a network protocol such as HTTPS to transmit the request to the server's endpoint. Terminal outputs a structured request packet that the server can parse for further processing.

### Step 9

Server performs inference with the generative AI model based on the prompt sentence.

Server accepts, as input, the request packet containing the prompt sentence and parameters. Server tokenizes the prompt text and maps style-or expression-related instructions into internal feature tokens or vectors. Server constructs an input sequence for the generative AI model that combines tokenized text and encoded conditions, then feeds this sequence into the trained network in inference mode. Server iteratively computes probability distributions for next tokens, applies a decoding algorithm such as beam search or nucleus sampling to select tokens, and concatenates the selected tokens into a generated sales-talk sequence. Server outputs the generated sales talk as character information, possibly with associated style and expression annotations, and prepares a response to the terminal.

### Step 10

Terminal receives the generated sales talk and prepares it for presentation.

Terminal obtains, as input, the response from the server containing the generated sales talk and associated data. Terminal parses the response, extracts the text content, and displays the sales talk in a text area on the display unit so that the user can read it. Terminal may store this text temporarily in local memory for subsequent operations. Terminal outputs both a visual representation of the generated text and internal data structures that can be used for speech synthesis and optional avatar control.

### Step 11

Terminal converts the generated sales talk into audio using a speech synthesis technique.

Terminal takes, as input, the generated sales-talk text and optional style parameters such as speaking rate, pitch, and voice type. Terminal invokes a text-to-speech engine, which converts the text into phonetic and prosodic representations and then into a digital audio waveform. Terminal may adjust synthesis parameters based on style information mapped from the original prompt or server-provided annotations. Terminal outputs synthesized audio data suitable for playback through the audio output unit.

### Step 12

Terminal outputs the synthesized audio and optional visual response to the user or customer.

Terminal receives, as input, the synthesized audio data and, if provided, instructions for facial expression and avatar behavior. Terminal sends the audio data to the audio output unit to play the generated sales talk and simultaneously renders a human-like figure on the display whose mouth and facial expressions change over time according to the instructions. Terminal thus outputs synchronized auditory and visual responses that present the generated sales talk in a human-like manner to the user and any customer present.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented sales support systems are typically limited to rule-based recommendation engines and static script playback. Such systems merely match products to simple conditions, such as category or price range, and output pre-authored messages. As a result, these systems cannot flexibly adapt to complex and evolving user preferences, cannot generate human-like persuasive conversations, and cannot maintain consistent quality of customer interaction at scale. Furthermore, conventional architectures often treat recommendation, natural language generation, and speech synthesis as isolated components, without a tightly integrated data flow from user behavior logs through prompt construction to generative output and controlled audio delivery. This separation leads to inefficient use of computational resources, increased latency in generating responses, and difficulties in maintaining a predictable and controllable conversation style.

In addition, existing systems frequently rely on static or generic prompts when using generative models, thereby underutilizing the ability of such models to personalize content based on rich behavioral data. Without a structured mechanism to automatically analyze user purchase history and browsing history, derive preference information, and encode that information into a dynamically generated prompt sentence, the output of a generative model can become inconsistent, irrelevant, or misaligned with the user's actual intent. From a computer technology standpoint, this indicates a lack of a systematic pipeline for transforming heterogeneous behavioral data into machine-understandable conditioning signals for generative models.

Moreover, when generative models are integrated into sales workflows, there is a risk that generated content may include inappropriate expressions or violate predefined communication policies. Conventional systems frequently handle such risks by manual review or coarse filtering, which does not scale and does not provide deterministic control over the content actually delivered to the user. This absence of integrated content filtering and policy enforcement at the system level results in unstable quality of remote sales interactions and undermines trust in automated sales agents.

There is also a technical challenge in efficiently coordinating data acquisition from user terminals, server-side analysis, generative AI processing, content filtering, and speech synthesis, while minimizing latency and preserving the conversational context. Conventional solutions may generate unnecessary network traffic, perform redundant processing, or fail to cache reusable intermediate results, leading to delays in response and reduced user engagement. These deficiencies illustrate that improvements are needed in the architecture of computer systems that implement remote sales, particularly in the way user behavior data is processed and transformed into controlled generative outputs and synthesized speech.

Accordingly, there is a need for a computer-implemented system and method that: (i) automatically acquires and structures user behavior information as purchase history information and browsing history information, (ii) analyzes such history information to derive preference information, (iii) constructs a prompt sentence that encodes the derived preference information and user behavior information as input to a generative AI model, (iv) generates sales talk information including product proposal information and persuasive sales conversation information in a consistent and controllable manner, (v) performs content filtering on the generated sales talk information according to predetermined expression constraints, and (vi) converts the filtered sales talk information into audio data for remote sales. By addressing these issues at the system architecture level, the present invention aims to improve computer technology in the field of automated remote sales, including data processing pipelines, generative model integration, and quality-controlled multimodal output generation.

The specific processing by the specific processing unit 290 of the data processing device 12 in Application Example 1 is realized by the following means.

The present invention provides a server comprising a processor and a storage device, wherein the processor is configured to acquire user behavior information from an information terminal device of a user via a communication network and store the user behavior information in the storage device as structured purchase history information and browsing history information; to analyze the purchase history information and the browsing history information stored in the storage device so as to derive preference information of the user including at least preference category information, price range information, and attribute information; to dynamically generate, on the basis of the derived preference information and the user behavior information, a prompt sentence that encodes the preference information and the user behavior information as input text for a generative AI model and instructs the generative AI model to generate product proposal information and personalized sales conversation information; to input the prompt sentence to the generative AI model and obtain, from the generative AI model, sales talk information including product proposal items corresponding to the preference information and persuasive sales conversation information; to perform content filtering on the obtained sales talk information in accordance with predetermined expression constraint information so as to remove or replace inappropriate expressions and generate filtered sales talk information; to convert the filtered sales talk information into audio data by using a speech synthesis technique; and to transmit the audio data to the information terminal device for reproduction as part of a remote sales user interface. This enables an improved computer-implemented remote sales system in which heterogeneous user behavior data is automatically transformed into a structured prompt sentence for a generative AI model, high-quality and policy-compliant sales talk information is generated and controlled at the server side, and latency-optimized audio output is delivered to the user terminal, thereby enhancing the efficiency, consistency, and technical performance of automated sales interactions.

The term “system” refers to a combination of at least one server device and at least one information terminal device, together with associated hardware and software components, that cooperatively execute the processes described in the claims.

The term “processor” refers to a hardware computing element, such as a central processing unit or other execution unit, configured to execute instructions to perform the functions specified in the claims.

The term “storage medium” refers to any non-transitory computer-readable medium capable of storing data or instructions, including but not limited to semiconductor memory, magnetic storage, and optical storage.

The term “user” refers to a person who operates an information terminal device and to whom product proposals and sales talk are provided.

The term “information terminal device” refers to an electronic device operated by the user, such as a portable communication device, a wearable device, or a general-purpose computing device, that is capable of communicating with the server and presenting a user interface.

The term “user behavior information” refers to information indicating actions or operations performed by the user on the information terminal device, including at least product viewing actions, selection actions, cart operations, and purchase operations.

The term “purchase history information” refers to a subset of the user behavior information that records products or services previously purchased by the user, together with associated attributes such as purchase time, price, and category.

The term “browsing history information” refers to a subset of the user behavior information that records products or services viewed by the user, together with associated attributes such as viewing time, viewing frequency, and category.

The term “preference information” refers to information derived from the purchase history information and the browsing history information that characterizes tendencies or interests of the user, including at least preference category information, price range information, and attribute information.

The term “preference category information” refers to a part of the preference information that indicates categories of products or services preferred by the user, determined by analysis of the purchase history information and the browsing history information.

The term “price range information” refers to a part of the preference information that indicates a range of prices typically associated with products or services purchased or browsed by the user.

The term “attribute information” refers to a part of the preference information that indicates one or more attributes associated with the user or with the products of interest, such as brand preference, function preference, usage scene, or user segment.

The term “prompt sentence” refers to a text string or sequence of text data generated by the processor, which encodes at least the preference information and the user behavior information, and is designed to be provided as input to a generative AI model.

The term “generative AI model” refers to a trained machine learning model capable of generating natural language text or similar content in response to input text, the model being configured to output sales talk information based on the prompt sentence.

The term “product proposal information” refers to information that identifies one or more candidate products or services to be recommended to the user, such as product identifiers, product names, categories, or brief descriptions.

The term “sales conversation information” refers to natural language text that expresses a dialogue or monologue suitable for sales activities, including explanations, recommendations, and persuasive statements directed to the user.

The term “sales talk information” refers to a set of information including at least the product proposal information and the sales conversation information generated by the generative AI model in response to the prompt sentence.

The term “content filtering” refers to processing performed by the processor on the sales talk information to detect, remove, or replace specific words, phrases, or expressions that are determined to be inappropriate according to predetermined rules or policies.

The term “expression constraint information” refers to information defining rules, conditions, or policies regarding permissible or impermissible expressions in the sales talk information, used as a basis for the content filtering.

The term “filtered sales talk information” refers to sales talk information that has been processed by the content filtering so that inappropriate expressions are removed or replaced according to the expression constraint information.

The term “speech synthesis technique” refers to a computer-implemented technique for converting text data into audio data representing a synthetic voice, including any text-to-speech processing method.

The term “audio data” refers to digital data representing sound, including at least voice data generated by the speech synthesis technique based on the sales talk information.

The term “communication network” refers to any wired or wireless communication infrastructure enabling data transmission between the server and the information terminal device.

The term “user interface” refers to a collection of visual, auditory, and/or interactive elements presented on the information terminal device to enable the user to receive the sales talk and to interact with product proposals.

The term “remote sales” refers to sales activities performed without physical face-to-face contact between the user and a human salesperson, using the system to deliver product proposals and sales talk via the communication network.

In an embodiment, a server cooperates with multiple terminals operated by users to implement an automated remote sales system that generates personalized sales talk based on user behavior information and delivers the sales talk as synthesized audio. The server includes at least one processor, a memory, a non-transitory storage device, and one or more network interfaces. The terminals include computing hardware such as a central processing unit, a memory, a display unit, an audio output unit, and a communication interface.

The server executes software components implemented, for example, using a server-side programming language and framework such as a scripting language runtime with a web framework or an interpreted language runtime with a web framework. The server stores user behavior information, model parameters, prompt templates, and configuration information in a database management system such as a relational database or a document database deployed on a storage device. The server communicates with a generative AI model execution environment via an application programming interface exposed over a network.

The terminal executes a web browser or a native application. The terminal uses an operating system such as a mobile operating system, a desktop operating system, or a wearable operating system to manage device resources. The terminal presents a user interface on a display, receives user operations via a touch panel, keyboard, or pointing device, and outputs audio via an internal speaker, wired earphones, or a wireless headset.

The server stores, in the storage device, behavior records representing purchase history information and browsing history information. Each behavior record includes, for example, fields such as a user identifier, a product identifier, a product category code, a timestamp, a price value, and additional attribute flags (e.g., brand identifier, usage scene tag, and device type). The server manages these behavior records in normalized relational tables or structured collections, enabling efficient querying by user identifier and by time range.

The server analyzes the purchase history information and the browsing history information using data processing modules. In one embodiment, the server loads, into memory, a batch of behavior records corresponding to a specific user and applies aggregation operations. The server groups the behavior records by product category code and counts the number of occurrences for each category. The server computes statistical measures, such as an average price and a standard deviation of prices, across the user's purchased and browsed products. The server determines a preferred price band for the user based on the computed statistics, for example by selecting a price interval that contains a majority of the user's purchases.

The server also analyzes attribute information by counting occurrences of brand identifiers, usage scene tags, or functional feature tags contained in the behavior records. The server assigns a score to each attribute based on frequency and recency. The server computes higher scores for attributes that are both frequent and recent. The server selects, as preference attribute information, those attributes whose scores exceed a threshold. In addition, the server may apply a clustering algorithm, such as k-means clustering implemented using a numerical computation library, to embed the user's historical products into a vector space and to assign the user to a cluster representing a user segment such as “running enthusiast” or “home appliance upgrader.”

The server constructs preference information for the user by combining preference category information, price range information, and attribute information. The server represents the preference information as a structured object in memory, containing, for example, a list of top categories, a lower and upper bound of a price range, and a list of prioritized attribute labels. The server then generates a prompt sentence in natural language by inserting these elements into a template stored in configuration storage.

In one example, the server generates the following prompt sentence:
“The user's purchase history is:
Category: running shoes, Price range: 100-150 units of currency, purchased twice in the last 6 months
Category: sportswear, Price range: 50-80 units of currency

The user's browsing history shows frequent views of cushioned running shoes and wearable fitness devices.

The inferred user segment is a running enthusiast with a mid-price preference.

You are a generative AI model acting as a skilled human sales representative.

Based on this information, generate:
1) three concrete product recommendations, and
2) a persuasive, friendly sales conversation that can be converted to speech.

Keep the conversation under 300 words and suitable for online shopping assistance.”

In another example, the server generates a prompt sentence specialized for home appliances:
“The user's purchase history includes multiple energy-efficient home appliances. The user's recent browsing history shows repeated views of large-capacity washing machines with quiet operation and quick-wash modes.

Please act as a highly experienced home appliance salesperson. Using this information, generate:
two or three washing machine recommendations that best fit a family household concerned about noise and time savings, and
a persuasive, empathetic sales talk suitable for an online shopping assistant.

The sales talk should mention how the recommended machines reduce laundry time, emphasize quiet nighttime operation, and end with a clear, gentle call to action to check out one of the recommended models.”

The server uses the generated prompt sentence as an input sequence to a generative AI model. In one embodiment, the generative AI model is implemented as a transformer-based neural network comprising an input embedding layer, multiple self-attention layers, feed-forward layers, and an output projection layer. The server tokenizes the prompt sentence using a subword tokenizer, maps tokens to integer indices, and passes the sequence of indices to the generative AI model hosted on an inference server equipped with parallel processing hardware such as graphics processing units or tensor processing units.

The generative AI model internally maintains learned weight matrices representing attention projections, feed-forward parameters, and embedding vectors. During inference, the generative AI model computes attention scores between tokens, applies softmax normalization, and generates contextualized embeddings. The generative AI model then uses a decoding algorithm, such as sampling with temperature control or top-p sampling, to sequentially generate output tokens corresponding to sales talk information. The generative AI model is trained in advance using a corpus of conversational data that includes human sales dialogues, product descriptions, and customer interaction transcripts. During training, the generative AI model minimizes a cross-entropy loss function between predicted token distributions and ground-truth tokens. The training process updates the weight parameters using gradient descent and backpropagation through time, with regularization techniques such as dropout and weight decay.

The server receives, from the generative AI model, the generated token sequence representing sales talk information. The server converts the token sequence to a text string and stores the text string in memory. The server then performs content filtering based on expression constraint information maintained as policy data in the storage device. The server, for example, maintains a list of disallowed phrases, a list of restricted claims about product performance, and constraints on politeness levels. The server scans the generated sales talk information using pattern matching or natural language processing-based classifiers, detects tokens or phrases that violate the expression constraint information, and replaces such elements with acceptable alternatives stored in a substitution table. The server thereby generates filtered sales talk information that satisfies the predefined policies.

The server converts the filtered sales talk information into audio data using a speech synthesis technique. In one embodiment, the server uses a text-to-speech system implemented either on the same server or on a remote synthesis service. The server specifies parameters such as a language code, a voice character (e.g., male or female, and tone), and a speaking rate. The text-to-speech system performs linguistic preprocessing, including text normalization and phoneme conversion, and applies a neural vocoder model, such as a sequence-to-sequence acoustic model followed by a waveform generator, to synthesize an audio waveform. The server receives the waveform data and encodes it in a compressed audio format such as a widely used audio container.

The server transmits the synthesized audio data to the terminal via a network using protocols such as Hypertext Transfer Protocol Secure or a streaming protocol. The terminal receives the audio data and stores it temporarily in a buffer or a file. The terminal uses its operating system media framework, such as an audio playback application programming interface, to decode the audio data and to output the decoded audio through an audio output unit. The terminal synchronizes the audio playback with the display of product recommendations on the screen, for example by highlighting items when they are mentioned in the audio.

The user listens to the audio output and interacts with the recommendations. The user may tap a product displayed on the screen, add a recommended product to a shopping cart, or scroll to view additional details. The terminal records these interactions as additional user behavior information, which the server later uses to refine the preference information and generate updated prompt sentences. This feedback loop enables the server to continuously adapt the generative AI model's conditioning context to the user's evolving preferences.

In one embodiment, the server optimizes processing speed and communication load by caching intermediate results. For example, the server caches, in a memory-resident store, recent preference information and partial prompt templates for frequently active users. When the terminal sends updated behavior information that only slightly modifies the user's profile, the server updates the cached preference information incrementally rather than recomputing it from all historical data. The server also caches frequently used segments of sales talk information corresponding to stable product recommendations. By reusing cached results where possible, the server reduces redundant computations and shortens the time required to generate and deliver audio responses.

The server further improves computational efficiency by designing the data structures of behavior records and preference information to support vectorized processing. The server stores numeric features representing product categories, price ranges, and attributes in dense vector representations, such as one-hot encoded vectors, multi-hot vectors, or learned embedding vectors. The server performs matrix operations using optimized numerical libraries, enabling batch computation of user segments and similarity scores across many users. This vectorized processing reduces computation time compared to sequential rule-based evaluation and contributes to scaling the system to a large number of users.

The server improves accuracy and stability of recommendations by using model architectures and learning methods that are distinct from simple human heuristics. For example, the server uses a neural network-based classifier to predict conversion likelihoods for candidate products, taking as input feature vectors composed of user preference features, product feature vectors, and interaction features such as dwell time or scroll depth. The server trains this classifier using supervised learning with a loss function that penalizes mispredictions of purchase events. The server uses the classifier output as an additional signal in the prompt sentence, for example by specifying that products with higher predicted conversion likelihoods should be emphasized in the generated sales conversation. This integration of predictive modeling into the prompt construction is an automated, algorithmic process that is not a simple replication of human manual selection.

The system also improves communication efficiency by compressing and structuring the prompt sentence to encode only the most relevant behavior information and preference information. The server applies selection algorithms to omit low-impact items from the prompt sentence, thereby reducing the length of input to the generative AI model. Shorter prompts result in faster inference on the model hardware and lower network transmission overhead. At the same time, the server retains critical features that significantly influence recommendation quality, such as dominant categories and recency-weighted behaviors. Through this careful selection, the server maintains a balance between prompt compactness and information richness, improving the overall performance of the generative AI model.

In another embodiment, the server employs different generative AI models or different model configurations for different product domains. The server may select, based on category information in the preference information, a domain-specific generative AI model that has been fine-tuned on a subset of training data corresponding to a particular vertical, such as sports equipment or home appliances. The server then modifies the prompt sentence to include domain-specific instructions. This configuration allows the system to achieve higher relevance and more appropriate language in each domain while maintaining a unified architecture for data processing and audio delivery.

The system further provides technical effects distinct from mere automation of human sales work. The server executes complex, non-intuitive transformations of high-dimensional behavior data into compact conditioning vectors, integrates these vectors into structured prompt sentences, and enforces machine-level content filtering rules that humans could not apply with comparable speed and consistency. As a result, the system delivers personalized and policy-compliant sales audio in near real time, with reduced latency and higher accuracy of product matching compared to conventional rule-based recommendation engines and static scripts.

The terminal contributes to the technical effects by controlling hardware for synchronized audio-visual output. The terminal coordinates the playback timing of audio with the rendering of user interface elements. The terminal may pre-buffer audio segments while rendering associated product tiles, so that the user experiences seamless playback without stuttering even under fluctuating network conditions. By coupling the audio decoding pipeline with the display rendering pipeline, the terminal reduces perceived latency and provides a more integrated interaction.

In yet another embodiment, the server adapts the parameters of the generative AI model over time using online learning techniques. The server periodically collects anonymized interaction statistics, such as acceptance rates of recommended products or user actions following specific phrases in the sales talk. The server uses these statistics to update adapters or additional layers of the generative AI model using fine-tuning procedures. The server minimizes a custom objective function representing negative feedback on ineffective phrases and positive feedback on successful recommendations. Through this feedback-driven updating process, the system improves both the precision of recommendations and the persuasiveness of conversation content.

Across these embodiments, the server configures and operates specialized data structures, algorithms, and model architectures to process user behavior information, to construct prompt sentences as precise conditioning inputs to a generative AI model, to filter and synthesize sales talk information into audio, and to control delivery to terminals. The system thereby improves computer technology in the domains of data management, machine learning-based content generation, and low-latency, multimodal user interface control.

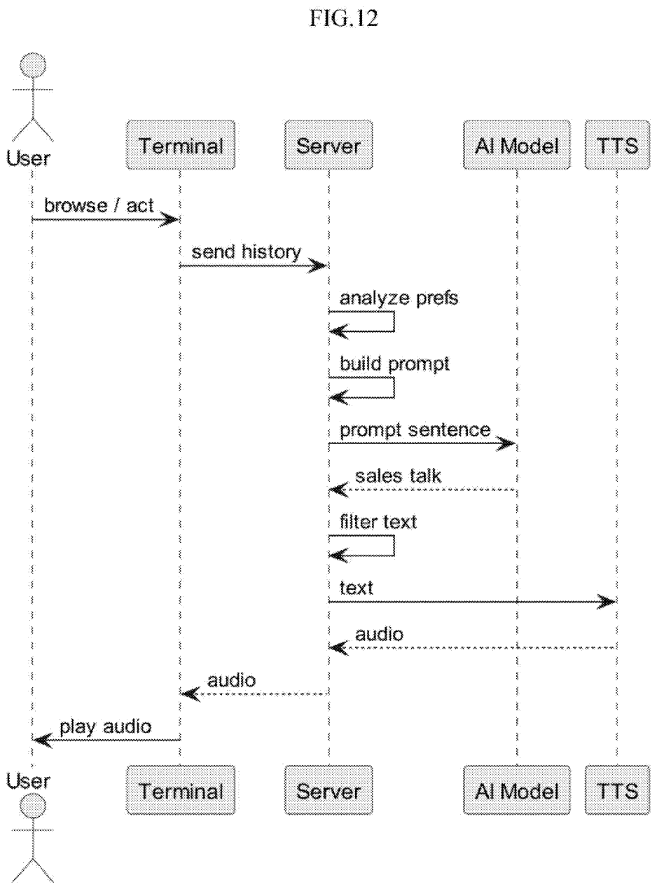

The following describes the processing flow using FIG. 12.

### Step 1

The user operates the terminal and accesses an online shopping service. The user views product lists, opens product detail pages, and optionally completes purchases. The input of this step is user interaction events such as taps, clicks, scrolls, and purchase confirmations on the terminal, and the output is raw interaction data within the terminal, including product identifiers, timestamps, and event types.

### Step 2

The terminal converts the raw interaction data into structured user behavior information. The terminal creates records that include at least a user identifier, a product identifier, a category code, a price value, a timestamp, and an event type (for example, “view,” “add_to_cart,” or “purchase”). The input of this step is the raw interaction events from the user interface, and the output is structured user behavior information stored temporarily in a local data structure or buffer on the terminal.

### Step 3

The terminal divides the structured user behavior information into purchase history information and browsing history information. The terminal classifies each record by checking the event type field and assigns “purchase” events to purchase history and other view-related events to browsing history. The input of this step is the structured user behavior information, and the output is two datasets: purchase history information and browsing history information stored in the terminal.

### Step 4

The terminal transmits the purchase history information and the browsing history information to the server via a communication network. The terminal encapsulates the data into a request message, attaches a user identifier or session token, and sends the message using a network protocol. The input of this step is the local datasets of purchase history and browsing history, and the output is a network request containing user behavior information delivered to the server.

### Step 5

The server receives the network request containing the purchase history information and the browsing history information. The server validates the request, parses the message payload, and extracts individual behavior records. The input of this step is the network request from the terminal, and the output is parsed data structures representing purchase history information and browsing history information stored in the server's memory.

### Step 6

The server stores the parsed purchase history information and browsing history information in a storage device. The server inserts or updates records in database tables or collections keyed by user identifier and time. The server may normalize the data by separating product attributes and user attributes into related tables. The input of this step is the parsed behavior information in memory, and the output is persistently stored purchase history information and browsing history information in a database managed by the server.

### Step 7

The server retrieves and aggregates behavior records for a target user to derive preference category information. The server queries the database for all relevant purchase and browsing records, groups them by product category code, and counts the occurrences. The server ranks categories by frequency and recency. The input of this step is the stored purchase history information and browsing history information for the user, and the output is preference category information representing a ranked list of categories preferred by the user.

### Step 8

The server calculates price range information based on historical purchase and browsing prices. The server extracts the price values from the user's records, computes measures such as mean, median, and standard deviation, and determines a price range that covers a majority of transactions. The server may, for example, define the price range as mean plus or minus one standard deviation. The input of this step is a set of price values from historical records, and the output is price range information specifying a lower bound and an upper bound of preferred prices.

### Step 9

The server derives attribute information from product and interaction attributes. The server analyzes fields such as brand identifiers, usage scene tags, and functional feature tags associated with each record. The server computes scores for each attribute by combining frequency, recency, and possibly interaction intensity (such as dwell time on a page). The server selects attributes whose scores exceed a threshold and designates them as preference attributes. The input of this step is historical behavior records enriched with attribute fields, and the output is attribute information indicating prioritized attributes of interest for the user.

### Step 10

The server constructs preference information by combining preference category information, price range information, and attribute information into a unified data structure. The server creates a preference profile object that includes fields for top categories, price range bounds, and a ranked list of attributes. The input of this step is the results of category, price, and attribute analyses, and the output is preference information stored in memory as a structured profile for the user.

### Step 11

The server generates a prompt sentence for a generative AI model. The server loads a prompt template from configuration storage and inserts elements from the preference information and user behavior information into placeholders within the template. The server assembles a natural language text that summarizes the user's purchase history and browsing history and explicitly instructs the generative AI model to produce product proposal information and personalized sales conversation information. The input of this step is the preference information and selected user behavior records, and the output is a complete prompt sentence represented as a text string in memory.

### Step 12

The server tokenizes the prompt sentence and prepares it as input for the generative AI model. The server applies a tokenizer to split the prompt sentence into subword tokens, converts tokens to numeric identifiers using a vocabulary table, and constructs a sequence of token identifiers. The input of this step is the prompt sentence text, and the output is a sequence of token identifiers suitable for processing by the generative AI model.

### Step 13

The server sends the token sequence or the original prompt sentence to the generative AI model execution environment. The server creates a request payload that includes the token sequence or text, along with configuration parameters such as maximum output length and sampling settings. The server transmits this payload over a network interface to a generative AI model endpoint. The input of this step is the encoded prompt sentence and inference parameters, and the output is a request message delivered to the generative AI model execution environment.

### Step 14

The server receives generated sales talk information from the generative AI model. The generative AI model processes the prompt sentence and returns output tokens or text representing sales talk information, including product proposal information and persuasive conversation sentences. The server decodes token outputs if necessary and reconstructs the output text. The input of this step is the response message from the generative AI model endpoint, and the output is raw generated sales talk information represented as a text string stored in server memory.

### Step 15

The server performs content filtering on the generated sales talk information according to expression constraint information. The server compares the generated text against a set of rules, prohibited phrases, and policy constraints, detects non-compliant segments, and replaces or removes them. The server may perform this operation using string matching, pattern recognition, or classifier outputs. The input of this step is the raw generated sales talk information and expression constraint information, and the output is filtered sales talk information that complies with predefined policies.

### Step 16

The server prepares text for speech synthesis from the filtered sales talk information. The server may adjust punctuation, insert pauses, or split the text into segments suitable for synthesis. The server ensures that the text is encoded in the correct character set and removes any control characters that could impair speech synthesis. The input of this step is the filtered sales talk information, and the output is a normalized text string ready for input to a speech synthesis engine.

### Step 17

The server submits the normalized text to a speech synthesis technique. The server constructs a synthesis request that includes the text, a target language, and voice parameters such as voice type and speaking rate. The server transmits this request to a speech synthesis engine either running locally or on a remote service. The input of this step is the normalized sales talk text and synthesis parameters, and the output is a synthesis request accepted by the speech synthesis engine.

### Step 18

The server receives audio data generated by the speech synthesis technique. The speech synthesis engine converts the text into an audio waveform, encodes it in a specific format, and returns the encoded audio data. The server optionally re-encodes or segments the audio for streaming. The input of this step is the response from the speech synthesis engine, and the output is audio data representing the synthesized sales talk stored in server memory or temporary storage.

### Step 19

The server transmits the audio data to the terminal via the communication network. The server encapsulates the audio data into a response message or stream, sets appropriate headers to indicate content type and length, and sends the message using a network protocol. The input of this step is the synthesized audio data on the server, and the output is an audio response delivered to the terminal.

### Step 20

The terminal receives the audio data and prepares it for playback. The terminal stores the audio data in a buffer or a temporary file and initializes an audio playback component provided by the operating system. The terminal decodes the audio format if required and loads the decoded samples into an audio playback buffer. The input of this step is the audio data transmitted from the server, and the output is a prepared audio stream in the terminal's audio subsystem.

### Step 21

The terminal plays back the audio stream to the user and synchronizes the playback with visual elements. The terminal outputs the audio through speakers or headphones and may highlight or scroll to recommended products on the display while specific items are mentioned in the audio. The input of this step is the prepared audio stream and associated product references, and the output is perceived audio and visual information presented to the user.

### Step 22

The user listens to the audio-based sales talk and interacts with the recommended products. The user may select a recommended product, add it to a cart, or ignore the suggestion and continue browsing other items. The input of this step is the audio and visual presentation from the terminal, and the output is new user actions that represent feedback on the recommendations and conversation.

### Step 23

The terminal records the new user actions as additional user behavior information. The terminal updates behavior records to capture events such as “clicked recommended item,” “purchased recommended item,” or “dismissed suggestion.” The input of this step is the user's follow-up interactions, and the output is augmented user behavior information. This augmented information is again transmitted to the server, causing subsequent iterations of preference analysis, prompt sentence generation, and generative AI model processing to refine future sales talk.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented sales support systems primarily focus on presenting static product descriptions or scripted sales dialogues that are manually authored and stored in a database. In such systems, the quality, depth, and structure of sales explanations depend heavily on manual content creation and manual rule design. As a result, these systems suffer from several technical problems in terms of information processing efficiency, adaptability, and consistency of generated output.

First, conventional systems lack a dynamic mechanism in the processor for generating natural-language sales explanations that are tailored to fine-grained product attributes and evolving user requirements. Even when a natural-language generation engine is used, the processor typically forwards user input directly to the engine without intermediate structuring or optimization, leading to suboptimal prompts that do not fully exploit the capabilities of a generative AI model. This often results in unnecessarily long processing times, redundant iterations, and inconsistent output quality across products and users.

Second, conventional systems do not provide the processor with an effective way to control the output tendency of a generative AI model at the level of internal prompt construction. In particular, there is no standardized, machine-enforceable mechanism for classifying attribute information by importance level and automatically adjusting sentence structure within prompts to cause the generative AI model to prioritize key features. Therefore, even when rich product data is available, the generated output may bury critical information in low-priority sections, causing inefficient use of computational resources as users repeatedly request revisions, and leading to unnecessary network traffic and server load.

Third, conventional systems generally lack a processor-level framework for maintaining consistency of expression format and content across different products and sessions while still allowing iterative refinement based on user feedback. In many cases, each interaction with a natural-language model is treated as an isolated request, with no reusable template logic that systematically embeds structured attribute information and user input. This results in fragmented processing flows, difficulty in guaranteeing consistent output structures, and increased complexity in downstream user interfaces and client applications that must cope with highly variable text formats.

Fourth, conventional systems do not integrate a closed-loop architecture in which user feedback is treated as structured control data for reconfiguring internal prompt sentences. As a result, user feedback is often applied manually or semi-manually, rather than being automatically combined with attribute information to reconstruct optimized prompts. This limits the ability of the system to adapt its generative behavior at run time using well-defined data flows, and prevents efficient, repeatable refinement of the generative AI model's output.

Accordingly, there is a need for an improved computer-implemented system in which the processor performs structured acquisition of attribute information, programmatic construction and reconstruction of prompt sentences, automatic control of the generative AI model's output tendency through importance-based rearrangement of prompt sentence structures, and template-based generation of prompts that ensure consistency across products. Such a system should reduce iterative trial-and-error interactions with the generative AI model, lower processing overhead on servers and communication networks, and provide a technically improved pipeline for generating and refining sales explanation information in a natural language in response to user feedback.

The specific processing by the specific processing unit 290 of the data processing device 12 in Example 2 is realized by the following means.

The present invention provides a server comprising a processor configured to acquire attribute information regarding a sales target from a structured information set stored in a storage device, to generate, on the basis of the acquired attribute information, a prompt sentence including an instruction sentence for explaining features and advantages of the sales target as input data for a generative AI model, to transmit the prompt sentence to the generative AI model via a communication network and receive response data including sales explanation information in a natural language generated on the basis of the prompt sentence, to perform formatting or structuring on the received sales explanation information and edit the sales explanation information as display data that is presentable to a user terminal, to transmit the edited display data to the user terminal, to receive, from the user terminal, user input including at least one of an additional condition and a modification request generated with reference to the presented sales explanation information, to reconstruct the prompt sentence on the basis of the user input and the attribute information, and to retransmit the reconstructed prompt sentence to the generative AI model so that the generative AI model repeatedly generates sales explanation information in accordance with a user request. This enables an improved computer-implemented information processing pipeline in which prompt sentences are systematically optimized and reused based on structured attribute data and user feedback, thereby controlling the behavior of the generative AI model, reducing redundant processing, and consistently generating refined natural-language sales explanations with enhanced efficiency and reliability.

The term “processor” refers to a hardware or virtual computation unit, such as a central processing unit, a microprocessor, or a processing core executed by a computing instance, that executes machine-readable instructions to perform operations defined in the present specification.

The term “storage device” refers to a hardware component or subsystem, such as a magnetic disk device, a semiconductor memory, an optical storage medium, or a network-based storage service, that stores data, programs, or configuration information in a non-transitory manner.

The term “structured information set” refers to a collection of data items organized according to a predefined schema or data model, such as a relational database, a key-value store, a document store, or a structured file, from which attribute information can be systematically retrieved by the processor.

The term “attribute information” refers to data representing properties, characteristics, parameters, or metadata of a sales target, including but not limited to feature data, specification data, classification data, and usage-related data, that are used by the processor to generate a prompt sentence.

The term “sales target” refers to any entity that is a subject of a sales activity, including, for example, a product, a service, a solution, or a combination thereof, for which sales explanation information is to be generated.

The term “prompt sentence” refers to machine-readable text data, composed as at least one sentence, that includes instructions, constraints, or contextual information and is provided as input to a generative AI model to control the content, structure, or style of generated output.

The term “generative AI model” refers to a machine-learned computational model, such as a neural network-based language model, configured to generate natural-language text or other content based on input data including a prompt sentence.

The term “response data” refers to data output by the generative AI model in response to a prompt sentence, including at least natural-language text representing sales explanation information and optionally metadata such as confidence scores or usage statistics.

The term “sales explanation information” refers to natural-language text that describes features, advantages, use cases, or other relevant aspects of a sales target so as to support sales activities or understanding by a user.

The term “formatting” refers to processing applied to sales explanation information, such as adding line breaks, headings, emphasis markers, or layout markers, to adapt the information to a desired presentation form.

The term “structuring” refers to processing that transforms sales explanation information into a logically organized form, such as dividing text into sections, paragraphs, or labeled fields, to facilitate systematic presentation or further machine processing.

The term “display data” refers to data that has been formatted or structured to be suitable for output by a user terminal, including but not limited to text data, markup data, and associated display attributes.

The term “user terminal” refers to an end-user computing apparatus, such as a smartphone, tablet, personal computer, or similar device, that communicates with the server via a communication network and presents information to a user.

The term “communication network” refers to any wired or wireless communication infrastructure, including local area networks, wide area networks, or public networks, by which the server and the user terminal exchange data.

The term “user input” refers to information provided by a user via the user terminal, including at least one of additional conditions, modification requests, or evaluation data, that is used by the processor to reconstruct a prompt sentence.

The term “additional condition” refers to a constraint, preference, or requirement, specified by the user, that supplements originally used attribute information and influences how subsequent sales explanation information is generated.

The term “modification request” refers to a user-specified instruction indicating a desired change in content, emphasis, style, or scope of sales explanation information previously generated by the generative AI model.

The term “reconstruct” refers to the act by which the processor alters, extends, or regenerates a prompt sentence by incorporating at least one of user input and attribute information to produce a new or updated prompt sentence.

The term “output tendency” refers to a statistical or behavioral pattern in the content, ordering, emphasis, or style of text generated by the generative AI model in response to prompt sentences.

The term “classification rule” refers to a set of criteria, implemented as program logic or configuration data, that is applied by the processor to group, rank, or label pieces of feature information or advantage information, for example by importance level or category.

The term “feature information” refers to data describing specific properties or characteristics of a sales target, such as performance, functions, or technical specifications, that may be included in sales explanation information.

The term “advantage information” refers to data describing benefits, merits, or positive effects associated with a sales target from a user's or customer's viewpoint.

The term “importance level” refers to a value, label, or rank assigned to pieces of feature information or advantage information to indicate their relative priority or significance in sales explanation information.

The term “sentence structure” refers to an arrangement and ordering of clauses, phrases, and sentences within a prompt sentence or generated text, including the sequence in which topics are introduced and emphasized.

The term “template data” refers to predefined data structures, such as text patterns or parameterized sentence frames, from which prompt sentences can be generated by inserting attribute information and user input.

The term “prompt-sentence generation template” refers to template data specifically designed for constructing prompt sentences, including placeholders or fields for attribute information, user input, and control instructions directed to the generative AI model.

The term “expression format” refers to a style or layout in which sales explanation information is written or presented, including aspects such as sentence length, use of headings, bullet points, or narrative structure.

The term “server” refers to an information processing apparatus, which may be implemented as one or more physical or virtual machines, that hosts the processor, the storage device, and associated software components used to perform the operations described in the present specification.

In one embodiment, a server includes a processor, a main memory, a non-transitory storage device, and a network interface, all connected via a system bus. The server executes an operating system such as a general-purpose server operating system and runs application software modules implemented, for example, in a high-level programming language. The server communicates with one or more terminals via a communication network such as the Internet or a corporate intranet. Each terminal comprises a processor, a memory, a display device such as a liquid crystal display or an organic light-emitting diode display, an audio output device such as a speaker or earphone jack, an input device such as a touchscreen or keyboard, and a network interface.

The server stores, in the storage device, a structured information set including attribute information of multiple sales targets. The structured information set may be maintained in a relational database management system, a key-value store, or a document-oriented database. For example, the server may use a relational database engine to store records of products or services, each record including fields such as identifier, name, category, specification parameters, functional features, performance metrics, typical use cases, and customer segment information. The server accesses the database through a database driver and loads attribute information into main memory as structured records, such as tuples or objects having fixed fields and types.

The server functions as an information processing apparatus that transforms the structured attribute information into optimized text input for a generative AI model. The server maintains a template repository in the storage device. The template repository stores multiple prompt-sentence generation templates, each associated with at least one category of sales target. A template may include fixed text segments and placeholders that are bound at runtime to attribute information values and user input values. The server loads a template into memory and performs substitution operations by inserting attribute values, such as numerical performance specifications and feature keywords, into corresponding placeholders. In this way, the server does not simply pass raw user instructions to the generative AI model, but instead constructs a prompt sentence with a controlled structure and content.

The server also stores a classification rule set. The classification rule set includes rule definitions that map feature terms and advantage terms to importance levels or semantic categories. For example, the server may store rules indicating that security-related or safety-related features are “high” importance, performance-related features are “medium” importance, and cosmetic features are “low” importance. The rules may be realized as pattern-matching expressions, weight tables, or decision trees that examine tokens and phrases present in attribute information fields.

The server analyzes attribute information by tokenizing feature strings, extracting keywords, and applying the classification rule set to assign importance levels. The server then prepares an ordered list of feature information and advantage information. The server arranges high-importance items at the beginning of the list and low-importance items at the end. When constructing the prompt sentence, the server places references to high-importance information earlier in the sentence sequence and may add additional emphasis markers in text, such as explicit instructions like “focus primarily on security and reliability.”

The server interfaces with a generative AI model that is implemented, for example, as a transformer-based neural network language model deployed on a remote computing infrastructure or locally on the server. In one embodiment, the generative AI model includes an encoder-decoder or decoder-only transformer architecture with multiple attention layers, feed-forward layers, and normalization layers. The generative AI model processes tokenized text sequences, where each token is represented as an embedding vector in a high-dimensional space. The model parameters, including weight matrices in attention heads and feed-forward layers, are stored in non-volatile memory and loaded into accelerators such as graphics processing units or tensor processing units when executing inference.

The generative AI model is trained in advance using a corpus of text data that includes general language material and optionally domain-specific sales material. During training, the model computes a loss function such as cross-entropy loss between predicted token distributions and ground-truth tokens, and a training algorithm such as stochastic gradient descent or an adaptive optimizer updates the model weights. The training process incorporates regularization techniques, such as dropout in intermediate layers and weight decay, to improve generalization. The server may optionally perform fine-tuning or instruction-tuning by further training the model on prompt-response pairs characterizing desired sales explanations, using the same loss function and updating weights for a subset or all layers.

In operation, the server converts the constructed prompt sentence into a token sequence by applying a tokenizer that maps character strings to token identifiers. The server supplies the token sequence to the generative AI model via an application programming interface, together with control parameters such as maximum output length, sampling temperature, and top-k or top-p sampling thresholds. Internally, the generative AI model computes successive output token probabilities conditioned on the prompt tokens and previously generated tokens. The server receives a sequence of output token identifiers and decodes them into a natural-language text string representing sales explanation information.

The server performs additional processing on the generated sales explanation information. The server may segment the text into paragraphs according to punctuation and sentence boundaries, insert headings such as “Key Features,” “Benefits,” and “Usage Scenarios,” and convert enumerations into structured sections. The server may store the formatted sales explanation information in the database, linked to the corresponding sales target identifier, and also store metadata such as timestamp, template identifier, and classification summary. The server then encapsulates the formatted explanation and metadata into a response object and transmits the response object to the terminal over the communication network.

The terminal receives the response object and parses the formatted sales explanation information. The terminal renders the content on the display device using a user interface framework. The terminal may display the sales target name as a title, followed by the explanation text in readable font with appropriate line breaks and headings. The terminal may also use the audio output device to provide synthesized speech output, for example by invoking a text-to-speech engine that converts the explanation text into audio samples. The terminal provides interactive controls enabling a user to scroll through the explanation, to copy particular sections, or to trigger a refinement request.

The user views the sales explanation information on the terminal and may determine that certain aspects require modification or further emphasis. The user operates the input device to enter additional conditions or modification requests, such as text specifying “emphasize extended battery lifetime and durability” or “simplify the explanation for non-technical customers.” The terminal collects the user input and transmits it to the server as control data associated with the corresponding sales target.

The server interprets the received user input as refinement instructions. The server parses the user input text, extracts keywords associated with feature categories or presentation style, and updates the importance levels or emphasis flags for relevant attribute information items. The server may, for example, increase the importance level of “battery lifetime” from medium to high, and add a style constraint indicating “avoid technical jargon.” The server then reconstructs the prompt sentence by reselecting and reordering feature information and advantage information according to the updated importance levels, and by embedding the style constraints as explicit textual guidance in the prompt sentence.

In one concrete example, the server may generate an initial prompt sentence such as: “You are a generative AI model specialized in sales writing. Based on the following product data, create a clear and persuasive explanation for sales staff:
Product name: XPhone Pro
Category: smartphone
Key features: 50-megapixel camera with optical image stabilization; 5000-milliampere-hour battery with fast charging; next-generation mobile connectivity.
Target customers: business users and frequent travelers.

Please generate an explanation that highlights the main benefits for these customers, avoiding overly technical jargon, and keep the length around 250 words.”

If the user then requests more emphasis on battery-related aspects, the server may reconstruct the prompt sentence as: “You are a generative AI model specialized in sales writing. Based on the following product data, create a clear and persuasive explanation for sales staff, placing primary emphasis on battery lifetime and reliability, and only secondary emphasis on camera performance:
Product name: XPhone Pro
Category: smartphone
Key features: 5000-milliampere-hour battery with fast charging and long-term durability; 50-megapixel camera with optical image stabilization; next-generation mobile connectivity.
Target customers: business users and frequent travelers.

Please generate an explanation that focuses first on how the long battery lifetime and durability benefit busy professionals and travelers, while describing the camera features more briefly, and keep the length around 250 words.”

By embedding explicit priority information and reordered feature lists into the prompt sentence, the server modifies the internal attention patterns of the generative AI model during inference. Empirically, placing high-importance tokens earlier and repeating key constraints in the prompt text causes the generative AI model to allocate more probability mass to sentences that discuss these aspects, thus aligning the generated output with the desired emphasis. As a result, the system reduces the number of refinement iterations needed and decreases the overall computation time and network usage per finalized explanation.

The server uses specific data structures and algorithms to achieve these improvements. Attribute information for each sales target is stored as a record containing arrays or lists of feature items, each feature item having fields such as “label,” “text description,” “importance score,” and “category code.” The server updates importance scores by applying rule-based functions or weighted sums of rule outputs. When constructing the prompt sentence, the server performs a stable sort on feature items according to importance scores and category codes, and then maps sorted feature items into textual segments according to the selected template. This procedure is executed by the processor using loops and sorting algorithms optimized for the size of the feature list, thus introducing only a small computational overhead compared to naive prompt construction while significantly improving generative alignment.

From a technical standpoint, this architecture improves computer technology in several ways. The server reduces redundant invocations of the generative AI model by programmatically controlling the model's output tendencies through structured prompts, which leads to fewer re-generations and reduced usage of compute resources on the server and model-hosting hardware. The server also reduces communication load between the server and the generative AI model environment by decreasing the number of prompt-response cycles, and between the server and the terminal by reducing the volume of revised explanation data that must be transmitted. Moreover, the server improves data management by storing classification results, template identifiers, and user preference profiles, enabling re-use of optimized prompt patterns for similar sales targets or for the same user over time.

In addition, the server performs non-conventional processing that differs from simple automation of human drafting. A human salesperson typically selects and describes product features in an ad hoc manner, based on intuition and past experience. By contrast, the server applies a systematic classification rule set, numeric importance scores, and structured templates, and exploits the statistical properties of the trained generative AI model to achieve consistent and repeatable behavior. The server thereby implements a machine-specific optimization layer between raw attribute information and model input, which is not naturally performed by humans and which is tailored to the computational characteristics of transformer-based architectures.

In another embodiment, the server may host the generative AI model locally rather than relying on an external model service. In this case, the server uses dedicated acceleration hardware and a model-serving framework. The server loads the model weights from the storage device into device memory of the accelerator and executes inference directly under control of the processor. The logical processing flow remains similar: the server constructs a prompt sentence, tokenizes it, feeds the token sequence to the model, and decodes the result. Local hosting may further reduce network latency and improve throughput in environments where large numbers of prompt sentences must be processed.

In yet another embodiment, the server may maintain multiple generative AI models with different capacities or training domains. The server may select a particular model based on the category of the sales target, the length of the requested explanation, or quality constraints. For example, a smaller model may be chosen for quick, internal-use summaries, while a larger model may be invoked for customer-facing explanations. The server controls model selection using a policy module that evaluates metadata associated with each request. This multi-model configuration enables further optimization of processing time and computation cost.

The terminal may provide additional functionality that cooperates with the server. For example, the terminal may cache frequently used explanations and display them without requiring a new request to the server. The terminal may also store user-specific preferences, such as preferred explanation length or vocabulary level, and include these preferences in each request, enabling the server to tailor the prompt sentence without requiring explicit user instruction each time. By shifting some preference storage to the terminal and some processing to the server, the system balances load and reduces redundant data transfers.

The user, through interaction with the terminal, effectively participates in configuring the generative behavior of the system; however, the user is not required to understand the internal model structure. The user specifies high-level conditions, and the server translates these conditions into low-level modifications of prompt sentences, classification scores, and template selections. Because these modifications are applied systematically and logged in association with specific sales targets, the system can reproduce a given explanation format at a later time or apply the same parameterization to similar products, thereby enhancing reproducibility and technical reliability.

The described embodiments can be varied without departing from the scope of the claims. For example, the specific database type, communication protocol, template format, or generative AI model architecture may be changed, as long as the server continues to acquire attribute information, construct and reconstruct prompt sentences in accordance with classification rules and templates, and interact with a generative AI model to generate and refine sales explanation information. The system may be deployed on a single physical machine, a cluster of machines, or a cloud environment. The particular arrangement of modules may also vary, such that part of the processing is performed on the terminal or on an intermediate gateway device, provided that the core operations as claimed are realized.

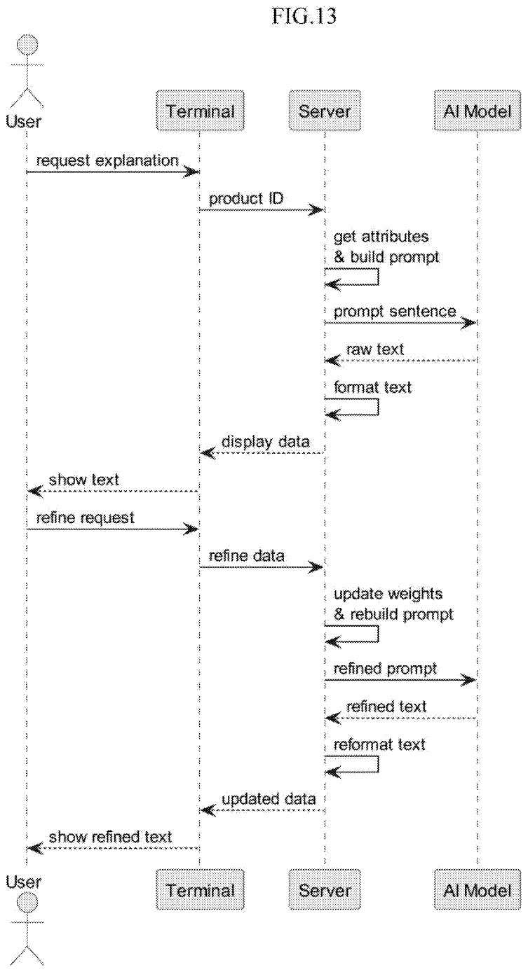

The following describes the processing flow using FIG. 13.

### Step 1

The server acquires attribute information of a sales target from a structured information set stored in a storage device. As input, the server receives at least a sales target identifier or a query condition from the terminal. The server uses this identifier or condition to execute a database access operation, for example, a query against a relational database table that stores product records. The server retrieves fields such as product name, category, feature list, specification parameters, and benefit descriptions. The server then converts the raw query result into an internal data structure, such as a record or object with named fields, and outputs this structured attribute information for further processing.

### Step 2

The server analyzes the acquired attribute information and assigns importance levels to feature information and advantage information. As input, the server takes the structured attribute information produced in Step 1. The server tokenizes text fields into words or phrases, applies a classification rule set to detect specific feature categories (for example, security, performance, usability), and computes importance scores based on predefined rules or weight tables. The server then associates each detected feature item with an importance level, such as high, medium, or low. The server outputs a list of annotated feature items, each item including at least a text description, a category, and an importance score.

### Step 3

The server selects a prompt-sentence generation template based on the sales target category and prepares an ordered feature list. As input, the server uses the sales target category and the annotated feature list generated in Step 2. The server looks up a template repository in the storage device and selects a template corresponding to the category, for example, a template designed for electronic devices or services. The server sorts the annotated feature list according to the importance scores, placing higher-importance items at the top. The server outputs the selected template and the ordered feature list as template input data.

### Step 4

The server generates an initial prompt sentence for a generative AI model by embedding attribute information into the selected template. As input, the server uses the template input data from Step 3, including the ordered feature list, sales target name, target customer segment, and any default style constraints. The server performs textual substitutions, inserting product-specific values and ordered feature descriptions into placeholder positions in the template, and concatenates these segments into a coherent text string. The server may also append instructions such as explanation length, level of technical detail, and emphasis priorities. The server outputs a complete prompt sentence that is ready to be sent to the generative AI model.

### Step 5

The server transmits the prompt sentence to a generative AI model and obtains a natural-language sales explanation. As input, the server takes the prompt sentence generated in Step 4 and model control parameters, such as maximum token count and sampling settings. The server converts the prompt sentence into a sequence of token identifiers using a tokenizer, and sends the token sequence and control parameters to the generative AI model through an application programming interface over the communication network or locally if the model resides on the server. The generative AI model performs internal neural computations to generate a sequence of output tokens conditioned on the prompt. The server receives the output token sequence, decodes it to text, and outputs a raw sales explanation text along with any metadata returned by the model.

### Step 6

The server formats and structures the sales explanation text for presentation on the terminal. As input, the server uses the raw sales explanation text from Step 5. The server analyzes sentence boundaries, identifies sentences that mention key features, and divides the text into logical sections such as introduction, key features, benefits, and usage scenarios. The server may insert headings, line breaks, and, if required, markup tags to improve readability. The server creates a display data object that includes the structured text and associated layout information. The server outputs this display data object as presentation-ready content.

### Step 7

The server transmits the display data to the terminal for output to the user. As input, the server uses the display data object generated in Step 6 and the network address of the requesting terminal. The server encapsulates the display data in a response message formatted according to a predefined protocol and sends the response through the communication network using, for example, a secure transport protocol. The server outputs the response message to the terminal, completing the server-side portion of the initial generation cycle.

### Step 8

The terminal receives the display data and presents the sales explanation information to the user. As input, the terminal receives the response message sent by the server in Step 7. The terminal parses the message, extracts the structured text and layout information, and renders the content on the display device using a user interface framework. The terminal may display the sales target name as a title, followed by headings and paragraphs corresponding to the explanation sections. If configured, the terminal may also forward the text to a local or remote text-to-speech engine and output audio through the audio output device. The terminal outputs the visual and/or auditory representation of the sales explanation to the user.

### Step 9

The user reviews the presented sales explanation and optionally generates refinement instructions. As input, the user perceives the explanation content displayed or spoken by the terminal in Step 8. The user determines whether certain features require more emphasis, simplification, or omission, and operates an input device on the terminal, such as a touchscreen keyboard or microphone, to enter additional conditions or modification requests. For example, the user may input text such as “please emphasize battery life more than camera performance” or “make the explanation easier for non-technical customers.” The user causes the terminal to send this user input to the server as refinement data.

### Step 10

The terminal transmits the user input to the server as control data for prompt reconstruction. As input, the terminal uses the user-entered refinement instructions from Step 9 and identifiers that associate the request with a specific sales target and explanation instance. The terminal constructs a request message containing the refinement text and relevant identifiers and sends the message to the server over the communication network. The terminal outputs this control message so that the server can adjust subsequent processing.

### Step 11

The server interprets the user input and updates importance levels and style constraints. As input, the server receives the control message containing refinement instructions and the previously stored annotated attribute information for the relevant sales target. The server parses the refinement text, extracts keywords corresponding to feature categories or presentation styles, and modifies the importance scores of affected feature items, for example by increasing the score of “battery life” and decreasing the score of “camera performance.” The server also updates style parameters, such as reducing technical terminology or changing tone. The server outputs an updated annotated feature list and an updated set of style constraints.

### Step 12

The server reconstructs a refined prompt sentence based on the updated annotations and style constraints. As input, the server uses the updated annotated feature list and the style constraints produced in Step 11, together with the original sales target attributes. The server re-sorts the feature items according to the new importance scores, regenerates the ordered feature list, and selects an appropriate template if a different emphasis or structure is required. The server then embeds the reordered feature descriptions and the explicit style instructions into the template, producing a new prompt sentence. The refined prompt sentence may include explicit phrases such as “focus primarily on extended battery lifetime and durability” or “use simple language suitable for non-technical readers.” The server outputs this reconstructed prompt sentence for another interaction with the generative AI model.

### Step 13

The server sends the refined prompt sentence to the generative AI model and obtains an updated sales explanation. As input, the server uses the reconstructed prompt sentence from Step 12 and the same or adjusted model control parameters. The server repeats the tokenization process, transmits the prompt to the generative AI model, and receives a new sequence of output tokens that are decoded into refined text. Because the prompt sentence now contains reordered and emphasized content, the generative AI model generates output that more strongly reflects the user's specified priorities. The server outputs the refined sales explanation text for subsequent formatting.

### Step 14

The server formats the refined explanation and updates the stored presentation data. As input, the server uses the refined explanation text obtained in Step 13. The server applies the same or similar formatting and structuring procedures as in Step 6, creating updated sections and adjusting headings, while ensuring that new emphasis is clearly visible. The server replaces or augments the previously stored explanation data in the database and prepares a new display data object representing the refined explanation. The server outputs this updated display data object.

### Step 15

The server transmits the updated display data to the terminal, and the terminal presents the refined explanation to the user. As input, the server takes the updated display data object from Step 14 and the terminal address, constructs a response message, and sends the message via the communication network. The terminal receives the response, parses it, and re-renders the explanation on the display device, optionally updating only the changed sections for efficiency. The terminal then outputs the refined explanation for the user, enabling the user to confirm that the explanation now matches the intended emphasis and style or to initiate further refinement if necessary.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented sales support systems and dialog systems typically rely on static scripts, fixed rule sets, and non-adaptive user interfaces. In such systems, a processor merely selects one of pre-stored messages based on coarse user input or simple branching logic. As a result, the system cannot flexibly adapt the content or style of responses to diverse user contexts, such as different customer attributes, changing emotional states, or detailed product histories. This leads to several technical problems in the field of computer technology.

First, existing systems do not provide an effective mechanism for dynamically generating and adjusting machine-readable instructions, such as prompt sentences, that control the behavior of a generative AI model in real time. Without such a mechanism, the processor cannot efficiently tailor the generative AI model's output to combine heterogeneous data sources, including product identification data, user identification data, historical behavior data, and emotion estimation results. This limits the system's capability to exploit available data and constrains the variety and relevance of generated content.

Second, traditional architectures treat emotion information and recommendation information, if used at all, as peripheral annotations rather than core control signals in the computational pipeline. Emotion recognition modules and recommendation engines often operate in isolation and do not directly influence the internal configuration of prompts supplied to a generative AI model. Consequently, the system cannot dynamically adjust the generative AI model's output characteristics, such as tone, level of detail, or emphasis, based on fine-grained emotion information and recommendation results. This reduces the system's ability to optimize information delivery and interaction flow at the time of execution.

Third, many systems lack an integrated feedback loop that continuously updates and improves the underlying models. Activity history, customer reaction, and outcome data are either not collected in a structured way or are not reused as learning-process data for retraining generative models and emotion estimation models. This results in a static model whose performance degrades or stagnates as user behavior, product offerings, and interaction patterns evolve. From a computer technology standpoint, this means that computational resources and accumulated interaction data are not effectively utilized to improve model accuracy, responsiveness, and robustness.

Fourth, existing systems require substantial manual intervention to create and maintain sales talk scripts and recommendation explanations. Human operators must repeatedly design and revise templates, which is error-prone and difficult to scale. The absence of automated prompt sentence generation tied to machine-learned policies leads to inefficiencies in processor usage and network traffic, since redundant or suboptimal content is often generated and transmitted. Accordingly, the overall processing pipeline is not optimized for dynamic, data-driven control of a generative AI model.

Therefore, there is a need for an improved computer-implemented system in which a processor is configured to (i) generate and update prompt sentences based on multi-type input data including user input information, identification information, history information, and emotion information, (ii) control a generative AI model in real time to produce context-adaptive response sentences, (iii) integrate emotion estimation and recommendation estimation as primary control signals for adjusting prompt content and model output characteristics, and (iv) collect and reuse interaction data as learning-process data to retrain and refine the generative AI model and related estimation models. Such a system would improve the technical field of computer-implemented dialog management, content generation, and recommendation by providing an architecture that dynamically configures and enhances the behavior of AI components under changing conditions, thereby increasing processing efficiency, adaptability, and quality of machine-generated outputs.

The specific processing by the specific processing unit 290 of the data processing device 12 in Application Example 2 is realized by the following means.

The present invention provides a server comprising a processor configured to (i) receive user input information and analyze target information, usage purpose information, and customer attribute information included in the user input information, (ii) generate a prompt sentence that defines a policy of a sales activity or an information-providing activity, (iii) acquire identification information from a terminal device and, based on the identification information, acquire at least one of merchandise identification data and user identification data and search a data group associated with the at least one of the merchandise identification data and the user identification data by a database reference process, (iv) obtain at least one of merchandise information, customer information, history information, behavior pattern information, preference estimation information, and emotion information, and supply the prompt sentence together with at least a part of the obtained information as input data to a generative AI model that generates a response sentence by natural language processing, (v) generate, by the generative AI model, at least one of a sales talk sentence, a merchandise explanation sentence, a recommendation explanation sentence, and a behavioral guideline sentence as the response sentence, (vi) analyze at least one of voice data and image data acquired from the terminal device by using an emotion estimation model to estimate an emotional state of a user and generate emotion information, (vii) dynamically adjust at least one of content of the prompt sentence and output characteristics of the generative AI model in accordance with the emotion information and, when necessary, in accordance with an estimation result of a recommendation estimation model that estimates recommendation target information from the at least one of the merchandise identification data and the user identification data, (viii) execute at least one of a voice synthesis process and a display control process based on the generated response sentence to convert the response sentence into at least one of voice data and display data and transmit the at least one of the voice data and the display data to the terminal device, and (ix) collect the response sentence, a result of the sales activity or the information-providing activity, and feedback information from the user as interaction data, perform preprocessing on the interaction data as learning-process data, and cause at least one of the generative AI model, the emotion estimation model, and the recommendation estimation model to relearn by using a machine learning framework. This enables the server to implement an integrated, data-driven control loop in which prompt sentences, model inputs, and model outputs are dynamically configured according to multi-type contextual information, such that the generative AI model can generate context-adaptive response sentences with improved relevance and effectiveness, and further enables continuous improvement of model performance and system behavior through iterative retraining based on accumulated interaction data, thereby enhancing computational efficiency, adaptability, and quality of computer-implemented dialog, recommendation, and information-providing functions.

The term “processor” refers to a hardware computing element, or a combination of hardware and software resources, that executes machine-readable instructions to perform data acquisition, analysis, generation, and transmission operations as described herein.

The term “terminal device” refers to an information processing apparatus operated by a user, such as a portable communication apparatus, a head-mounted display apparatus, or another user interface apparatus, that communicates with the processor and presents information to the user.

The term “user input information” refers to information received from a user through the terminal device, including at least one of textual input, selection input, speech input, and gesture input, indicating a target, a usage purpose, or a customer attribute.

The term “target information” refers to information indicating an object of a sales activity or an information-providing activity, including at least one of a product category, a service category, and a specific item to be introduced.

The term “usage purpose information” refers to information indicating a purpose or intended use of a system or a product, including at least one of a user goal, a desired function, and an intended scenario of use.

The term “customer attribute information” refers to information indicating characteristics of a customer or a user, including at least one of demographic information, behavioral information, preference information, and segment information.

The term “prompt sentence” refers to a machine-readable instruction sentence or group of sentences supplied to a generative AI model to condition or control generation of a response sentence in accordance with a policy of a sales activity or an information-providing activity.

The term “generative AI model” refers to a trained machine learning model that performs natural language processing to generate text data, such as a response sentence, in accordance with an input prompt sentence and optional auxiliary data.

The term “response sentence” refers to text data generated by the generative AI model in response to a prompt sentence, including at least one of a sales talk sentence, a merchandise explanation sentence, a recommendation explanation sentence, and a behavioral guideline sentence.

The term “sales activity” refers to an activity for proposing, explaining, or promoting a commodity or a service to a customer, including at least one of remote communication, in-store communication, and online communication.

The term “information-providing activity” refers to an activity for supplying explanation information, support information, or guidance information to a user, irrespective of whether a direct sales purpose is involved.

The term “sales talk sentence” refers to a response sentence that contains phrases, explanations, and suggestions intended to promote a commodity or a service in the context of a sales activity.

The term “merchandise explanation sentence” refers to a response sentence that describes features, functions, benefits, or usage methods of a commodity or a service.

The term “recommendation explanation sentence” refers to a response sentence that explains recommended items or services and reasons for recommending them based on history information, behavior pattern information, or preference estimation information.

The term “behavioral guideline sentence” refers to a response sentence that indicates an action policy or a conversational strategy to be followed by a human operator or by a system in a sales activity or an information-providing activity.

The term “identification information” refers to information received from the terminal device that uniquely or quasi-uniquely identifies at least one of a user, a customer, a merchandise item, or a session, including at least one of an identifier, a code, and a token.

The term “merchandise identification data” refers to data that identifies an item of goods or services, including at least one of a product code, a category code, and a resource identifier.

The term “user identification data” refers to data that identifies a user or a customer, including at least one of a user ID, a customer ID, and an account identifier.

The term “data group” refers to a logically related set of records stored in a storage apparatus, including at least one of merchandise records, customer records, behavior records, and interaction records associated with identification data.

The term “database reference process” refers to a process in which the processor issues a retrieval request to a storage structure, such as a relational database or a key-value store, to search for and obtain a data group corresponding to given identification information.

The term “merchandise information” refers to information relating to a commodity or a service, including at least one of a name, a specification, a price, a description, and a category.

The term “customer information” refers to information relating to a customer, including at least one of profile information, contact information, purchase history, inquiry history, and preference information.

The term “history information” refers to information representing past events associated with at least one of a user, a customer, or a merchandise item, including at least one of purchase history, browsing history, and communication history.

The term “behavior pattern information” refers to information that represents tendencies in user or customer actions over time, including at least one of frequency information, sequence information, and time-series activity information.

The term “preference estimation information” refers to information indicating estimated likes, dislikes, or interests of a user or a customer, derived from history information and behavior pattern information by a computational process.

The term “emotion information” refers to information indicating an estimated emotional state of a user or a customer, including at least one of categories, intensities, and temporal changes of emotions.

The term “emotion estimation model” refers to a trained machine learning model that receives input data such as voice data, image data, or text data and outputs emotion information indicating an estimated emotional state.

The term “recommendation estimation model” refers to a trained machine learning model that receives at least one of merchandise identification data, user identification data, history information, behavior pattern information, and preference estimation information, and outputs recommendation target information indicating items or services that are likely to be of interest.

The term “recommendation target information” refers to information indicating one or more commodities or services that are estimated as suitable or likely to be selected by a user or a customer.

The term “emotion state of the user” refers to a mental condition of the user at a given time as inferred from observed signals, including at least one of interest, boredom, satisfaction, dissatisfaction, and confusion.

The term “output characteristics of the generative AI model” refers to properties of text generated by the generative AI model, including at least one of tone, style, length, level of detail, and emphasis on specific topics.

The term “voice data” refers to digital data representing an acoustic signal of speech or sound, captured by a sound-collecting device or generated by a voice synthesis process.

The term “image data” refers to digital data representing a still image or a moving image, captured by an imaging device such as a camera.

The term “voice synthesis process” refers to a process in which the processor causes a synthesis component to convert text data into voice data representing synthesized speech.

The term “display control process” refers to a process in which the processor controls a display device of the terminal device to present text, graphics, or other visual information corresponding to a response sentence.

The term “interaction data” refers to data that collectively represents an interaction between a user and the system, including at least one of response sentences, user actions, activity results, customer reactions, and explicit feedback information.

The term “feedback information” refers to information supplied by a user, an operator, or another system to evaluate or comment on a generated response sentence, an interaction outcome, or system behavior.

The term “learning-process data” refers to data prepared as input for training or retraining a machine learning model, obtained by preprocessing interaction data, history information, or other collected data.

The term “relearn” refers to an operation in which a machine learning model is trained again or fine-tuned based on new learning-process data, so as to update model parameters and improve performance.

The term “machine learning framework” refers to a software platform or library that provides functionality for defining, training, and executing machine learning models, including at least one of support for neural network computation and optimization processing.

In the following embodiments, a server, a terminal, and a user cooperate to implement the claimed system. The embodiments are illustrative and do not limit the scope of the claims.

### A. Overall Hardware and Software Configuration

A server comprises at least one processor, a main memory, a non-volatile storage device, and a network interface. The processor may be a multi-core general-purpose processor or a combination of a central processing unit and a graphics processing unit. The memory stores program modules and model parameters. The storage device stores databases including merchandise records, customer records, history records, and interaction logs. The network interface communicates with a terminal over a wired or wireless network.

A terminal comprises at least one processor, a memory, a display device, a sound output device, an imaging device, and a sound-collecting device. The display device may be a flat panel display or a head-mounted display. The imaging device may be a front or rear camera. The sound-collecting device may be a microphone. The terminal executes a client program that interacts with the server through an application-level protocol such as HTTP over TLS.

The server executes an application program implemented in a general-purpose programming language. The application program incorporates a natural language processing library, a machine learning framework, and a database driver. As examples, the server uses a natural language processing library to tokenize and normalize text, and uses a machine learning framework such as a deep learning library to train and execute neural network models. The server uses a relational database management system to store identification data and structured records.

The server loads into memory at least three machine learning models: a generative AI model for generating response sentences in natural language, an emotion estimation model for estimating an emotional state from audio and image features, and a recommendation estimation model for estimating recommendation targets from history information and behavior pattern information. The generative AI model is, for example, a transformer-based language model comprising stacked self-attention layers and feedforward layers. The emotion estimation model is, for example, a convolutional neural network for image features combined with a recurrent neural network for acoustic features. The recommendation estimation model is, for example, a neural collaborative filtering model that learns user and item embeddings.

### B. Data Structures and Internal Modules

The server stores merchandise information, customer information, and history information in table structures. The server represents each merchandise item by a merchandise identification data field, a category field, a specification field, a price field, and a textual description field. The server represents each customer by a user identification data field, attribute fields, and preference fields. The server represents history information as records containing a user identification data field, a merchandise identification data field, a timestamp field, and an action type field.

The server maintains interaction data in a log structure. The log structure includes a session identifier, a prompt sentence, a response sentence, customer reaction information, and result information such as success or failure of a sales activity.

The server includes a prompt generation module, a database reference module, a model input preparation module, a generative AI inference module, an emotion analysis module, a recommendation inference module, a post-processing module, a synthesis and display control module, and a training and retraining module. Each module is implemented as executable instructions that operate on the above data structures.

The terminal includes a capture module to obtain image data and voice data, a rendering module to display text and graphics on the display device, an audio playback module to output synthesized speech, and a communication module to send and receive messages to and from the server.

### C. Generation of a Prompt Sentence and Model Input

The server receives user input information from the terminal. The user input information includes one or more of textual queries, menu selections, and speech transcriptions. For example, the user may input a question:
“How do I use this product?”

The server uses a natural language processing library to segment the user input information into tokens, perform part-of-speech tagging, and extract named entities such as product names and action verbs. The server classifies the intent of the input as, for example, a usage inquiry for a specific product.

The server acquires identification information such as merchandise identification data and user identification data from the terminal or from previous session records. The server invokes the database reference module to retrieve related merchandise information and customer information. The database reference module executes index-based lookups to minimize latency and reduce unnecessary disk access, thereby improving processing speed and lowering communication overhead.

The server constructs a prompt sentence by combining the extracted intent, the retrieved merchandise information, and the customer attribute information. For example, the server generates a prompt sentence such as:
“You are an expert support assistant. The customer asked the following question: ‘How do I use this product?’. The product has the following features: high-capacity battery, water resistance, and wireless connectivity. The customer is a beginner user. Explain step-by-step how to use the product in a simple and reassuring tone.”

The server formats the prompt sentence as a sequence of tokens and feeds it into the generative AI model together with auxiliary features such as merchandise category vectors and customer attribute vectors. By embedding structured features along with the prompt sentence, the server causes the generative AI model to condition its generation on both free-form text and structured attributes, which is a non-conventional combination in contrast to simple template substitution.

### D. Emotion Estimation and Dynamic Adjustment

The terminal captures voice data and image data representing the user's speech and facial expressions while the user interacts with the system. The terminal compresses these data and transmits them to the server.

The server uses the emotion analysis module to transform the voice data into acoustic feature vectors such as Mel-frequency cepstral coefficients, pitch contours, and energy statistics. The server converts image data into normalized pixel tensors and may compute facial landmarks. The server inputs these features to the emotion estimation model.

The emotion estimation model comprises, for example, convolutional layers for image features, recurrent layers for temporal audio features, and a fusion layer that outputs an emotion probability vector for categories such as interest, boredom, confusion, and frustration. The server computes an emotion information structure from the probability vector, including a dominant emotion label and its intensity.

The server dynamically adjusts at least one of the content of the prompt sentence and output characteristics of the generative AI model based on the emotion information. For example, when the server detects that the user's interest is decreasing, the server extends the prompt sentence to include directions such as:
“The customer's interest is decreasing. Generate a very short explanation that focuses only on the two most important benefits and include a brief mention of a special discount.”

By explicitly encoding such instructions into the prompt sentence, the server modifies the internal attention patterns and decoding behavior of the generative AI model without changing the underlying model parameters. This use of emotion information as a direct control signal for prompt design improves the technical operation of the generative AI model, enabling it to generate more relevant and concise outputs, thereby reducing token usage and network transmission payload.

### E. Recommendation Estimation and Explanation

The server uses the recommendation inference module to process history information and behavior pattern information. The server constructs user and item feature vectors by embedding user identification data and merchandise identification data into latent spaces learned during prior training. The recommendation estimation model uses matrix operations and non-linear activation functions to compute recommendation scores for candidate items.

The server selects top-ranked items as recommendation target information. The server then constructs a specific prompt sentence for the generative AI model that explains these recommendations. For example, the server generates a prompt sentence such as:
“The user often purchases sports-related products such as running shoes and training wear. The following items are recommended: lightweight running shoes, a breathable sports T-shirt, and a compact gym bag. Explain in three sentences why these items fit the user's preferences and encourage the user to consider them.”

The server inputs this prompt sentence and structured recommendation results into the generative AI model. Because the model receives both free-form descriptive language and structured selection results, the model can generate an explanation sentence that directly addresses the reasons for recommending each item. This improves the interpretability and utility of the recommendation process, which is a technical improvement over systems that provide only unannotated recommendation lists.

### F. Generation, Synthesis, and Presentation of Response Sentences

The server causes the generative AI inference module to execute the generative AI model on specialized hardware such as a GPU. The generative AI model comprises multiple transformer layers, each including multi-head self-attention sublayers and position-wise feedforward sublayers. The server uses an autoregressive decoding algorithm with beam search or nucleus sampling to generate tokens of the response sentence.

The server applies a post-processing filter to enforce maximum length, eliminate repeated segments, and standardize formatting such as bullet points and paragraphs. This post-processing reduces redundancy and improves clarity, which leads to reduced communication bandwidth and faster rendering on the terminal.

When the server is configured to provide voice output, the server uses the synthesis and display control module to convert the response sentence into voice data. The server uses a text-to-speech engine that implements, for example, a sequence-to-sequence acoustic model with an attention mechanism and a neural vocoder. The server selects a voice profile and prosody parameters based on the emotion information and the desired tone indicated in the prompt sentence.

The server transmits the voice data and the text of the response sentence to the terminal. The terminal uses the audio playback module to output the synthesized speech, and uses the rendering module to display the text on the display device. The user perceives the explanation or sales talk in a manner that is synchronized with their current emotional state and context.

### G. Training and Retraining of Models

The server uses the training and retraining module to update the generative AI model, the emotion estimation model, and the recommendation estimation model. The server collects interaction data including prompt sentences, response sentences, user actions, customer reactions, and results of sales activities. The server performs preprocessing such as anonymization, tokenization, normalization, and feature extraction to convert the interaction data into learning-process data.

The server defines error functions for each model. For the emotion estimation model, the server uses cross-entropy loss between predicted emotion probabilities and labels derived from explicit user feedback or heuristic rules based on behavior. For the recommendation estimation model, the server uses a ranking loss or a pairwise loss based on observed purchases and non-purchases. For the generative AI model, the server optionally uses a combination of maximum likelihood loss for next-token prediction and reinforcement learning-based loss that rewards outputs correlated with successful outcomes.

The server updates model weights by gradient-based optimization algorithms such as stochastic gradient descent, Adam, or RMSprop. The server may perform mini-batch training on historical data and fine-tuning on recent interaction data. Because the server executes incremental retraining, the models adapt to new merchandise, evolving customer behavior, and changing language patterns. This continuous learning mechanism yields technical effects of improved prediction accuracy, reduced error rates in emotion estimation, and more effective text generation.

### H. Technical Effects and Improvement of Computer Technology

The server improves computer technology in several concrete ways. By representing prompt sentences as dynamically generated control instructions that integrate multi-type data (identification information, history information, emotion information, and recommendation results), the server enables the generative AI model to act as a programmable component whose behavior can be finely tuned without re-compiling code or manually editing rule sets. This architecture reduces the need for large sets of static templates and simplifies configuration changes, thereby increasing maintainability and decreasing memory footprint.

The server's use of emotion information and recommendation information as primary control signals for prompt design and model output characteristics leads to shorter and more relevant response sentences. This reduces the average number of generated tokens and the size of transmitted data, which in turn decreases communication load between the server and the terminal and improves response time as perceived by the user.

The modular training and retraining pipeline described above reuses interaction data in a structured manner to refine model parameters. As a result, the server increases the precision of emotion estimation and recommendation ranking, which reduces the number of incorrect or ineffective responses. This contributes to lower computational waste in subsequent sessions because fewer unnecessary interactions are generated and transmitted.

The described system does not merely automate a human sales script. The server uses internal, non-obvious data structures, feature representations, and neural architectures (transformer layers, convolutional layers, recurrent layers, and embedding layers) to compute control signals and outputs that a human operator cannot feasibly compute in real time across large volumes of history information and multi-modal signals. The combination of prompt sentence generation, emotion-driven adjustment, recommendation-aware explanation, and iterative retraining produces a new technical capability: a self-optimizing dialog control mechanism that adapts generative behavior at runtime based on context and model feedback.

Because the server compresses high-dimensional behavioral and emotional data into latent feature vectors and embeds them directly into the generative pipeline, the server improves computational efficiency compared to systems that repeatedly perform separate rule-based checks for each interaction. The use of vectorized operations and GPU-accelerated inference further reduces latency and increases throughput, enabling the server to serve many terminals simultaneously with adaptive responses.

### I. Variations and Alternative Embodiments

The server may be configured to operate with different numbers or types of models. In one embodiment, the server uses a single multi-task neural network that outputs both response sentences and emotion estimates. In another embodiment, the server deploys separate models on different physical machines and aggregates their outputs through a message queue system.

The terminal may be a head-mounted display that overlays merchandise explanations in the user's field of view when the user looks at a product. In such an embodiment, the server uses vision-based product recognition in addition to barcode recognition. The server then generates a prompt sentence such as:
“The customer is currently viewing a new smartphone in the store. The smartphone has a high-resolution camera, a long-life battery, and a water-resistant body. The customer appears interested. Generate an explanation that highlights these three features and suggests a suitable use case.”

The system may also be applied to non-sales information-providing activities, such as technical support, training, or guidance in complex equipment operation. In such cases, the server still uses the same architecture: it generates prompt sentences that encode task policies, uses a generative AI model to generate detailed instructions, estimates user emotion, and adjusts explanations accordingly.

In all embodiments, the server, the terminal, and the user cooperate through the described modules and data structures so that the claimed system can be implemented by a person skilled in the art.

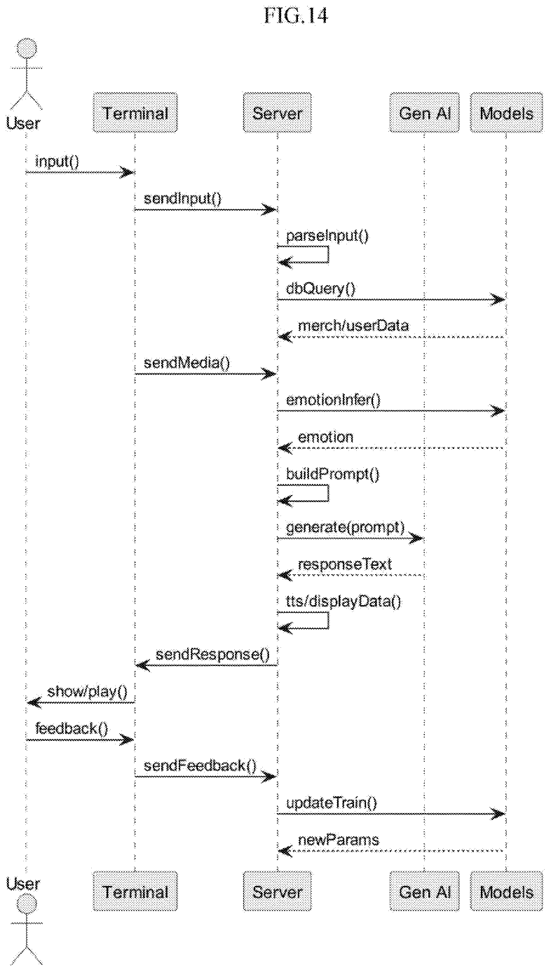

The following describes the processing flow using FIG. 14.

### Step 1

User provides initial input information.

User operates the terminal and inputs initial information, such as a spoken question, a typed query, or a selection of a product.

Input: A natural language utterance (for example, “How do I use this product?”), a selected product, or a menu selection.

Terminal captures the input via a touch interface, keyboard, or microphone, converts speech to audio data if necessary, and encapsulates the input into a request message that includes provisional identification information (for example, user ID, session ID, and optional product ID).

Output: A structured input message containing user input information and identification information, ready to be transmitted to the server.

### Step 2

Terminal transmits user input and context to the server.

Terminal sends the structured input message to the server over a secure communication channel.

Input: User input information (text or audio), identification information (user ID, session ID, optional product ID), and device metadata (for example, device type and locale).

Terminal formats these data in a predefined protocol format (for example, JSON over HTTPS), attaches timestamps, and forwards the request through the communication module.

Output: A network request received by the server containing user input information and context.

### Step 3

Server parses user input information and extracts semantic elements.

Server receives the request from the terminal and invokes a natural language processing module.

Input: User input text (or audio that the server first converts to text using a speech-to-text component) and identification information.

Server tokenizes the text, performs part-of-speech tagging, and applies named-entity recognition to extract entities such as product names, action verbs, and parameters. Server also performs intent classification using a trained classifier (for example, a neural network or a support vector machine) to determine whether the input is a usage question, a purchase intention, a complaint, or another category.

Output: A semantic representation consisting of an intent label, extracted entities, and cleaned user input text.

### Step 4

Server acquires merchandise and customer information by database reference.

Server uses the identification information and extracted entities to query internal databases.

Input: User identification data (user ID), merchandise identification data (product code or derived from product name), and the intent label.

Server issues one or more database queries to retrieve merchandise information (name, category, specifications, price, attributes) and customer information (profile, past purchases, behavior features). The server may also retrieve history information such as previous interactions in the same session.

Server then converts the raw database records into normalized data structures (for example, dictionaries or objects) and may encode categorical values as numerical feature vectors.

Output: Merchandise information, customer information, and history information associated with the current user and target product.

### Step 5

Server computes emotion information from audio and image input.

Terminal may have sent voice data and image data representing the user's speech and facial expressions together with or shortly after the initial request.

Input: Audio data (for example, sampled waveform) and image data (for example, frames captured by the camera).

Server extracts acoustic features such as Mel-frequency cepstral coefficients, energy, and pitch from the audio, and extracts visual features such as normalized face images or facial landmarks from the image data. Server supplies these feature vectors to an emotion estimation model (for example, a convolutional and recurrent neural network). The model computes probabilities for multiple emotion categories and outputs emotion information, including a dominant emotion label and an intensity score.

Output: Emotion information indicating the estimated emotional state of the user (for example, “slightly anxious, interest low”).

### Step 6

Server prepares recommendation target information, if applicable.

Server determines whether recommendation is appropriate based on intent and context.

Input: User identification data, merchandise identification data, history information, behavior pattern information, and preference estimation information (derived from prior interactions and purchases).

Server encodes users and items as embedding vectors using the recommendation estimation model. Server performs matrix multiplications and non-linear transformations to compute scores for candidate items. Server ranks the candidates and selects top N items as recommendation target information.

Output: A list of recommendation target items with associated scores and minimal product descriptors.

### Step 7

Server generates a context-specific prompt sentence for the generative AI model.

Server invokes a prompt generation module to construct a control instruction for the generative AI model.

Input: Semantic representation (intent and entities), merchandise information, customer information, emotion information, and optionally recommendation target information.

Server assembles these data into a natural language prompt sentence that encodes a policy for response generation. For example, when the user requests usage instructions and appears anxious, the server generates:
“You are an expert support assistant. The customer asked: ‘How do I use this product?’. The product has a high-capacity battery, water resistance, and wireless connectivity. The customer is a beginner user and appears slightly anxious. Explain step-by-step how to use the product in a simple and reassuring tone. Keep the explanation concise but complete.”

During this process, the server may remove redundant details, enforce a maximum length, and add explicit instructions about tone, level of detail, and structure.

Output: A finalized prompt sentence and structured auxiliary features that will be supplied to the generative AI model.

### Step 8

Server constructs model input tensors for the generative AI model.

Server converts the prompt sentence and auxiliary features into numerical representations.

Input: Prompt sentence, merchandise category vectors, customer attribute vectors, emotion feature vector, and optional recommendation result vector.

Server uses a tokenizer to map the prompt sentence into token IDs and applies positional encodings. Server embeds numerical features into a unified latent space (for example, through linear projections or embedding layers). Server then combines text token embeddings and auxiliary embeddings as input tensors suitable for the transformer-based generative AI model.

Output: Input tensors representing the prompt sentence and context, ready for inference by the generative AI model.

### Step 9

Server executes the generative AI model to produce a response sentence.

Server runs the generative AI model on the prepared input tensors.

Input: Encoded prompt tokens and auxiliary feature tensors.

Server performs forward propagation through multiple transformer layers, where each layer computes self-attention scores and feedforward transformations. Server uses an autoregressive decoding loop with beam search or nucleus sampling to generate the next token step by step until an end-of-sequence token or a length constraint is reached. The generative AI model uses information in the prompt sentence and embeddings (including emotion and recommendation signals) to select tokens that match the desired tone, length, and content.

Output: A sequence of output tokens forming a response sentence, such as a sales talk, a merchandise explanation, or a recommendation explanation.

### Step 10

Server post-processes the generated response sentence.

Server converts token IDs back into text and applies formatting and filters.

Input: Token sequence representing the generated response and the original prompt sentence.

Server decodes the tokens to characters or words, removes undesirable repetitions, truncates overly long sections, and normalizes punctuation and spacing. Server may insert headings, bullet points, or short paragraphs depending on the interaction type. Server may also check for compliance with internal rules (for example, maximum number of sentences, avoidance of prohibited phrases) and, if necessary, regenerate part of the response by adjusting the prompt sentence or decoding parameters.

Output: A clean and formatted response sentence suitable for display or voice synthesis.

### Step 11

Server performs voice synthesis and display data generation.

Server prepares output modalities according to device capabilities and user preferences.

Input: Formatted response sentence, emotion information, and terminal capability information (for example, whether audio is enabled).

Server invokes a text-to-speech engine to generate voice data from the response sentence, choosing voice type and prosody parameters consistent with the desired tone (for example, calm, energetic). In parallel, server constructs display data such as a text structure, layout hints, and emphasis markers for highlighting important phrases.

Output: Voice data (audio stream or file) and display data (text and layout information).

### Step 12

Server transmits response data to the terminal and logs interaction data.

Server sends the generated outputs to the terminal and stores the interaction for learning.

Input: Voice data, display data, prompt sentence, response sentence, emotion information, recommendation result, and meta-information such as timestamps and outcome tags (if available).

Server transmits the voice data and display data to the terminal via the network interface. Simultaneously, server writes an interaction log record containing the prompt sentence, the response sentence, user ID, product ID, and intermediate signals (emotion, recommendation scores) to a database or log store.

Output: A network response message delivered to the terminal and a persisted interaction log for future training.

### Step 13

Terminal presents the response to the user.

Terminal receives the server response and provides multimodal output.

Input: Voice data and display data received from the server.

Terminal uses the audio playback module to output the synthesized voice through speakers or headphones, and uses the rendering module to display the response sentence on the display device, possibly with highlighted keywords and scrollable sections. Terminal may also synchronize captions with the audio.

Output: Perceived audio explanation or sales talk and visual text content presented to the user.

### Step 14

User reacts to the response and optionally provides feedback.

User listens to or reads the generated response and takes an action.

Input: Presented explanation, sales talk, or recommendation explanation.

User may purchase a recommended item, ask a follow-up question, close the dialog, or provide explicit feedback such as a rating or a comment.

Output: New user actions or feedback, which become additional user input information for subsequent cycles.

### Step 15

Server collects feedback and updates learning-process data.

Server receives user actions and feedback via the terminal and prepares them for model retraining.

Input: User feedback (ratings, comments), observed outcomes (for example, purchase success, abandonment), and logged interaction data (prompt sentence, response sentence, emotion information, recommendation scores).

Server appends feedback fields to existing interaction records, computes derived labels (for example, success flag, satisfaction level), and performs preprocessing such as normalization, anonymization, and feature extraction. The server then stores the processed records as learning-process data in a training dataset.

Output: Updated training datasets for the generative AI model, the emotion estimation model, and the recommendation estimation model.

### Step 16

Server retrains or fine-tunes models using accumulated interaction data.

Server periodically or conditionally executes a training pipeline to improve model performance.

Input: Learning-process data containing sequences of prompt sentences, response sentences, labels for success or failure, emotion labels, and recommendation outcomes.

Server batches the data and computes gradients of predefined loss functions for each model: cross-entropy for emotion classification, ranking loss for recommendation, and likelihood or reinforcement learning-based loss for text generation. Server updates weights using optimization algorithms and validates the updated models on held-out data. Once the server determines that performance has improved, the server deploys the new model parameters into the inference environment.

Output: Updated model parameters for the generative AI model, the emotion estimation model, and the recommendation estimation model, which will be used in subsequent executions of Steps 3 to 11.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

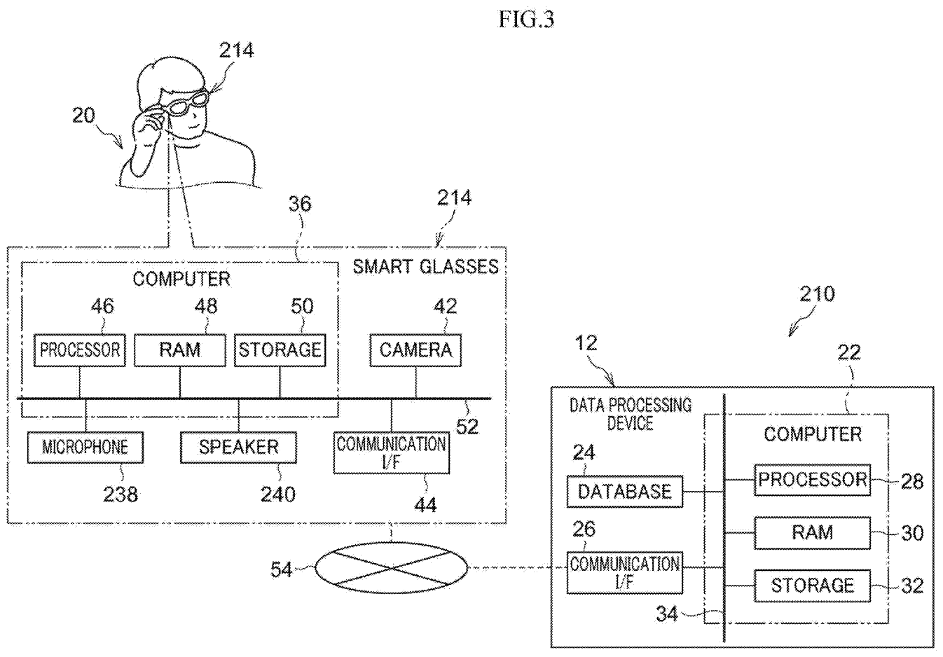

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

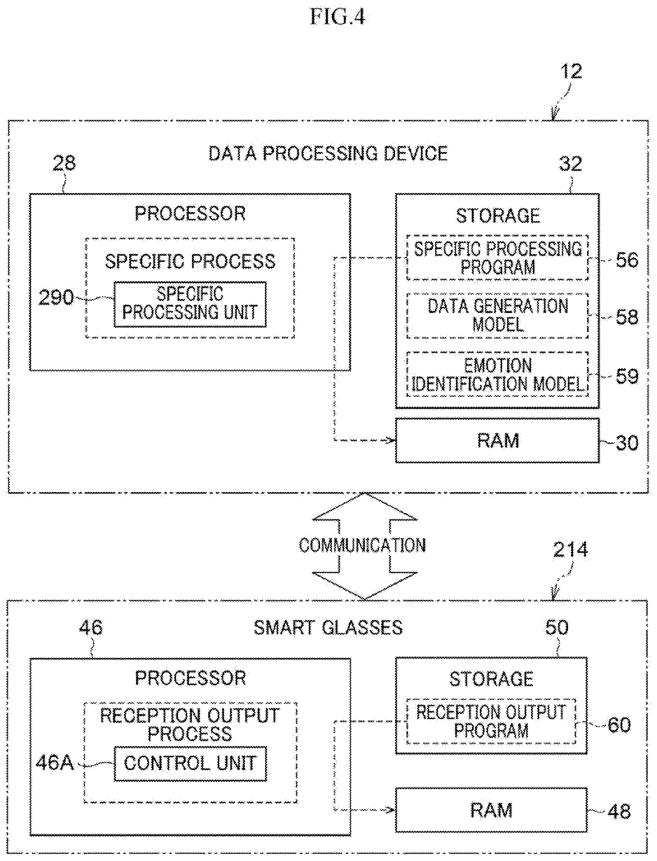

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

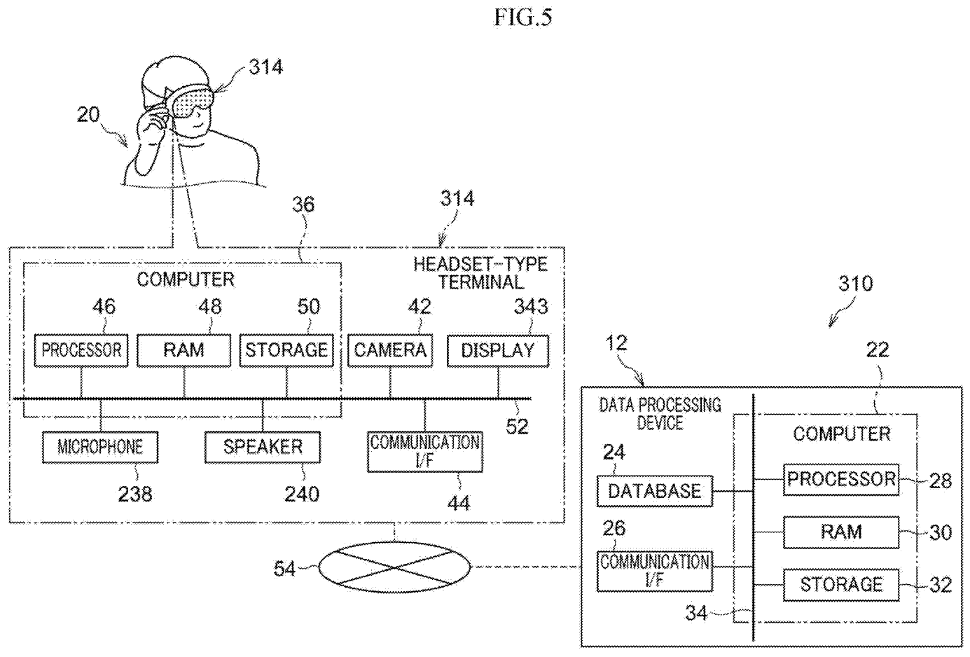

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

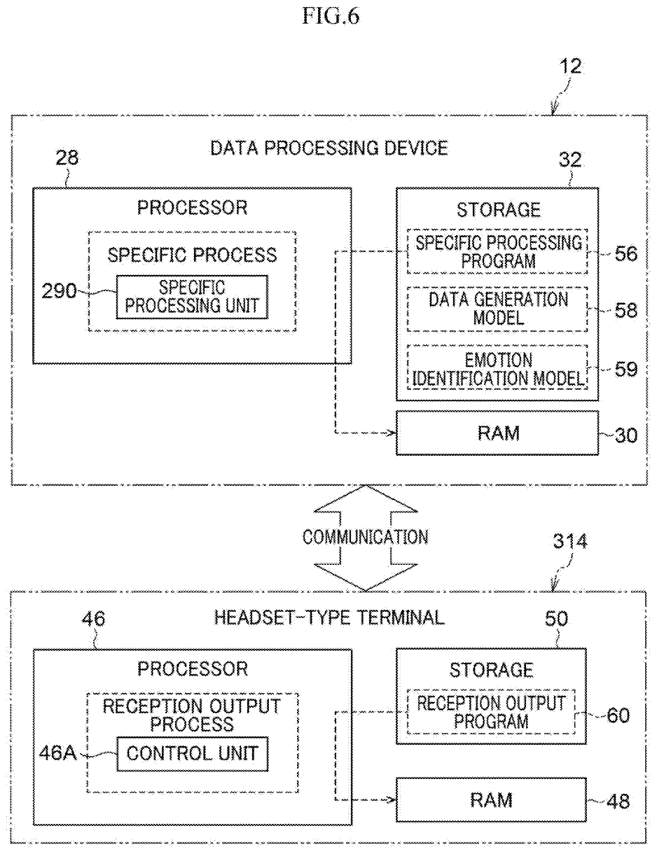

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

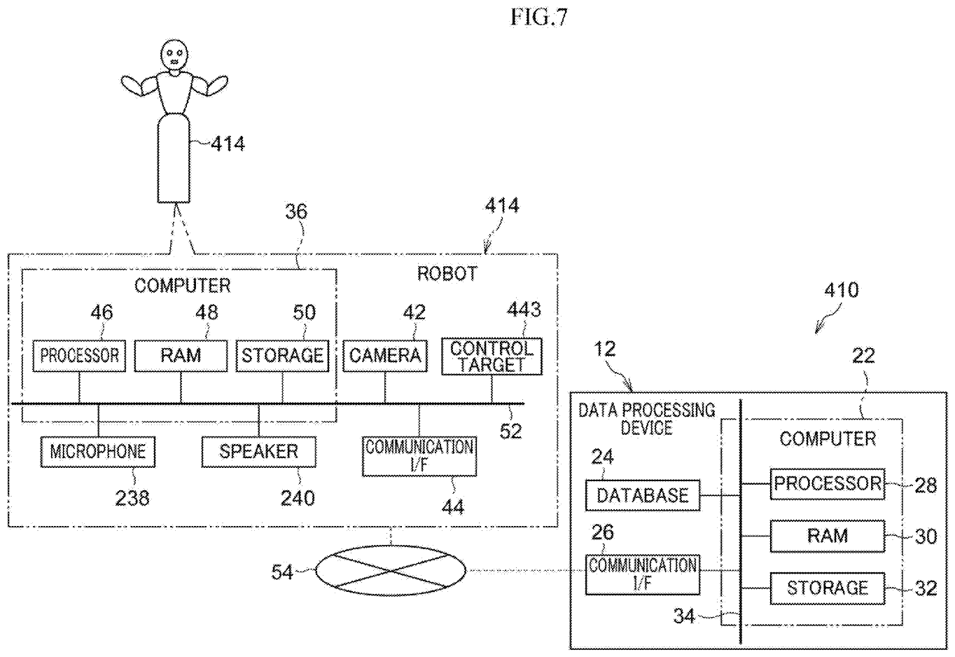

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

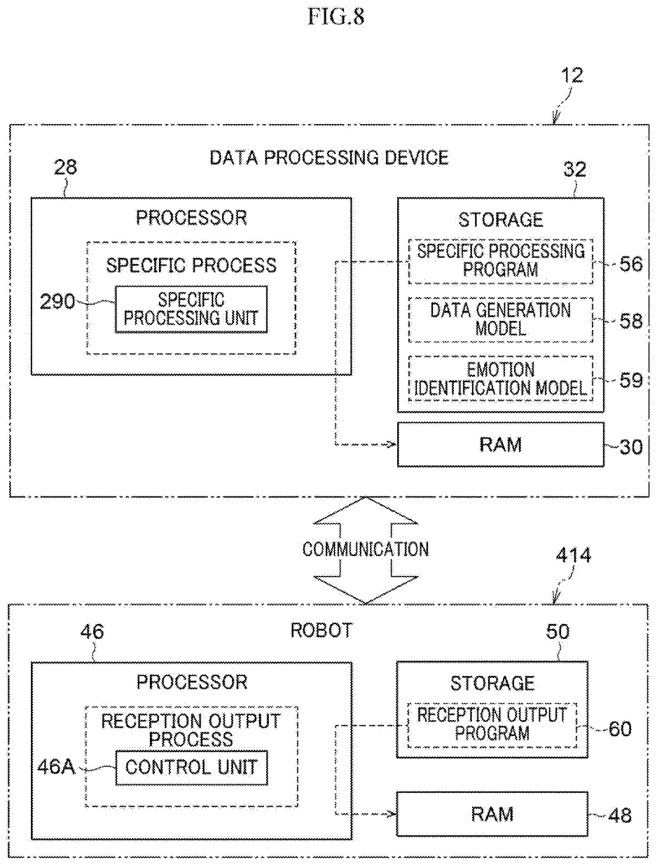

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

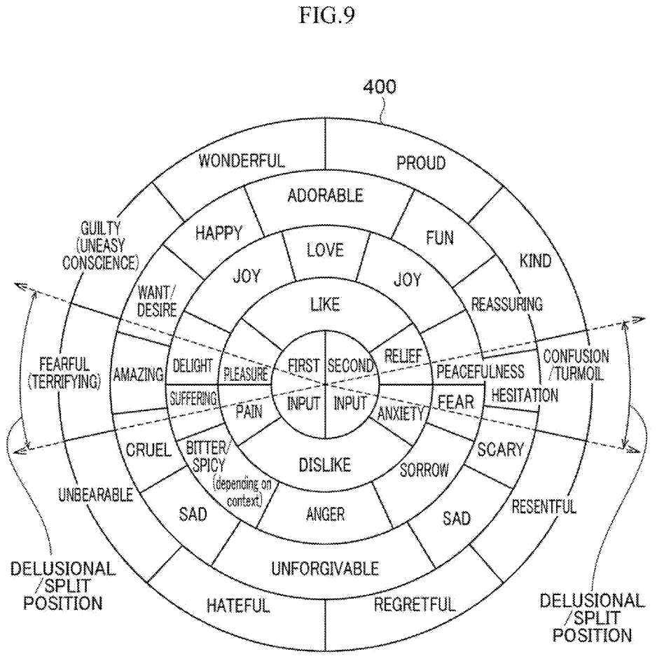

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

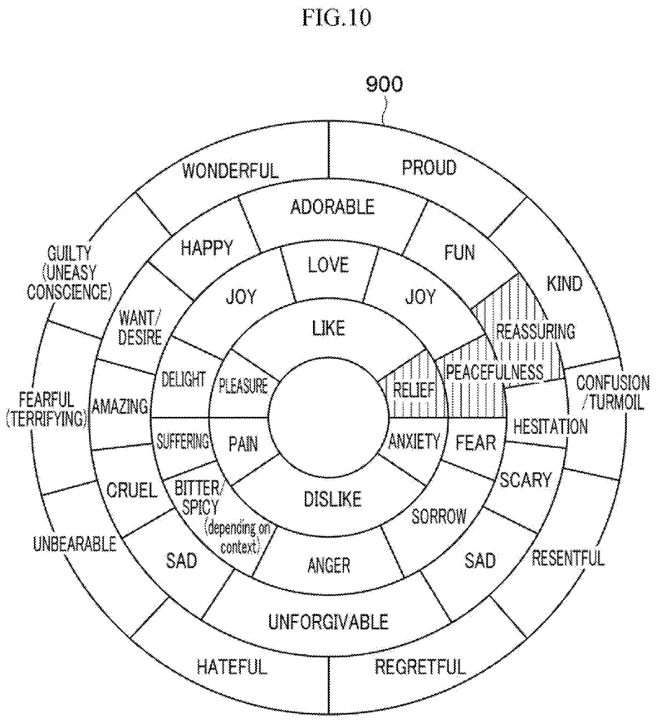

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor,
wherein the processor is configured to
acquire sales-related audio information and image information, generate character information indicating speech content of a speaker from the audio information, generate feature information indicating a facial expression state of the speaker from the image information, and store the character information and the feature information in association with each other,
train a generative AI model using the character information and the feature information by applying a generative artificial intelligence technique, and construct the generative AI model so as to be capable of generating sales talk conditioned on speech patterns and facial expression states in sales activities,
receive, from a user, a prompt sentence including instructions regarding sales conditions, target customer attributes, speaking style, and facial expression state, and configure input information supplied to the generative AI model based on the prompt sentence, input the prompt sentence to the generative AI model and generate, by the generative AI model, sales talk corresponding to the sales conditions, the target customer attributes, the speaking style, and the facial expression state included in the prompt sentence, convert the generated sales talk into audio information by using a speech synthesis technique and transmit the audio information to a terminal of the user, and
provide, to the terminal of the user, a user interface that displays character information of the generated sales talk and receives a user operation including reproduction control.

### Supplementary 2

The system according to supplementary 1,
wherein the processor is configured to
control the user interface so as to present, based on the feature information regarding the facial expression state associated with the sales talk generated by the generative AI model, a visual response using a human-like figure and an auditory response using the audio information, thereby anthropomorphizing the generative AI model to perform customer interaction.

### Supplementary 3

The system according to supplementary 1,
wherein the processor is configured to
standardize speech patterns and facial expression states in sales activities by using the sales talk generated by the generative AI model and the audio information output by the speech synthesis technique, and provide an automated sales process that does not depend on variation in ability or motivation of human sales personnel.

### Application Example 1

### Supplementary 1

A system comprising a processor,
wherein the processor is configured to
acquire user behavior information from an information terminal device of a user and store the user behavior information as purchase history information and browsing history information in a storage medium,
analyze the purchase history information and the browsing history information to derive preference information of the user, and generate a prompt sentence including the preference information and the user behavior information, the prompt sentence being configured as input text for a generative AI model,
input the prompt sentence into the generative AI model to cause the generative AI model to generate sales talk information including product proposal information corresponding to the preference information and persuasive sales conversation information,
convert the sales talk information into audio data by using a speech synthesis technique, and transmit the audio data via a communication network to the information terminal device of the user, and
control presentation of a user interface on the information terminal device to perform remote sales by reproducing the audio data on the information terminal device.

### Supplementary 2

The system according to supplementary 1,
wherein the processor is configured to
classify and aggregate the purchase history information and the browsing history information to extract preference category information, price range information, and attribute information of the user as the preference information, dynamically generate the prompt sentence on the basis of the preference information, and instruct, through the prompt sentence, the generative AI model to generate a plurality of product proposal items and personalized sales conversation information adapted to the preference information.

### Supplementary 3

The system according to supplementary 1,
wherein the processor is configured to
perform content filtering on the sales talk information generated by the generative AI model, remove or replace an inappropriate expression included in the sales talk information on the basis of predetermined expression constraint information, and then input the filtered sales talk information to the speech synthesis technique so as to maintain a predetermined quality level of customer response in the remote sales.

### Example 2

### Supplementary 1

A system comprising a processor,
wherein the processor is configured to
acquire attribute information regarding a sales target from a structured information set stored in a storage device,
generate, on the basis of the acquired attribute information, a prompt sentence including an instruction sentence for explaining features and advantages of the sales target, the prompt sentence being generated as input data for a generative AI model,
transmit, via a communication network, the prompt sentence to the generative AI model and receive, from the generative AI model, response data including sales explanation information in a natural language generated on the basis of the prompt sentence,
perform formatting or structuring on the received sales explanation information and edit the sales explanation information as display data that is presentable to a user terminal,
transmit the edited display data to the user terminal via the communication network so that the user terminal outputs the display data by an output device in at least one of a visual form and an auditory form,
receive, from the user terminal, user input including at least one of an additional condition and a modification request that is generated by a user with reference to the presented sales explanation information, and
reconstruct the prompt sentence on the basis of the user input and the attribute information, and retransmit the reconstructed prompt sentence to the generative AI model so that the generative AI model repeatedly generates sales explanation information in accordance with a user request.

### Supplementary 2

The system according to supplementary 1,
wherein the processor is configured to
extract, from the sales explanation information, a plurality of pieces of feature information and advantage information in accordance with a classification rule, classify the plurality of pieces of feature information and advantage information by importance level, and
automatically adjust a sentence structure of the prompt sentence so as to control an order of explanation or a degree of emphasis in accordance with the importance level, thereby controlling an output tendency of the generative AI model such that key points of the sales target are preferentially explained.

### Supplementary 3

The system according to supplementary 1,
wherein the processor is configured to
select, in accordance with a type or attribute information of the sales target, a prompt-sentence generation template from among a plurality of template data, and embed the attribute information and the user input into the selected template so as to generate, for each sales target, a prompt sentence having a consistent format, thereby automating a sales activity while maintaining consistency of an expression format and content of the sales explanation information output by the generative AI model.

### Application Example 2

### Supplementary 1

A system comprising a processor,
wherein the processor is configured to
receive input information from a user, analyze target information, usage purpose information, and customer attribute information included in the input information, and generate a prompt sentence that defines a policy of a sales activity or an information-providing activity, and input the prompt sentence and at least one of merchandise information, customer information, and emotion information into a generative AI model that generates a response sentence by natural language processing, and generate, as the response sentence, at least one of a sales talk sentence and a merchandise explanation sentence, and
execute at least one of a voice synthesis process and a display control process based on the response sentence to convert the response sentence into at least one of voice data and display data, and transmit the at least one of the voice data and the display data to a terminal device of the user, and
acquire identification information from the terminal device and, based on the identification information, acquire at least one of merchandise identification data and user identification data, and search a data group associated with the at least one of the merchandise identification data and the user identification data by a database reference process, and
analyze at least one of voice data and image data acquired from the terminal device, generate emotion information by using an emotion estimation model that estimates an emotional state of the user, and dynamically adjust at least one of content of the prompt sentence and output characteristics of the generative AI model in accordance with the emotion information, and
collect the response sentence generated by the generative AI model, a result of the sales activity or the information-providing activity, and feedback information from the user, perform preprocessing on the collected information as learning-process data, and cause at least one of the generative AI model and the emotion estimation model to relearn by using a machine learning framework, and
construct an estimation model that estimates recommendation target information by using, as an input, at least one of history information, behavior pattern information, and preference estimation information based on the at least one of the merchandise identification data and the user identification data, supply to the generative AI model a prompt sentence for generating an explanation sentence including an estimation result of the estimation model, generate a recommendation explanation sentence by the generative AI model, and transmit the recommendation explanation sentence to the terminal device.

### Supplementary 2

The system according to supplementary 1,
wherein the processor is configured to
receive, from the terminal device, facial expression information and voice information of the user acquired by an imaging function and a sound-collecting function of the terminal device, estimate emotion information based on the facial expression information and the voice information, change the prompt sentence to be input to the generative AI model in accordance with the emotion information, and cause the generative AI model to generate a response sentence in which detailed information is emphasized when a degree of interest of the user increases and a response sentence in which main points and benefit information are emphasized when the degree of interest of the user decreases.

### Supplementary 3

The system according to supplementary 1,
wherein the processor is configured to
accumulate activity history information, customer reaction information, and result information relating to the sales activity or the information-providing activity, automatically generate, based on the accumulated information, a prompt sentence describing a sales policy corresponding to at least one of a customer attribute, price sensitivity, and preference tendency, input the prompt sentence to the generative AI model to generate at least one of a behavioral guideline sentence and a sales talk proposal for a sales representative, and present the at least one of the behavioral guideline sentence and the sales talk proposal to the terminal device so as to provide a consistent sales process that does not depend on variation in human ability or motivation.

What is claimed is:

1. A system comprising:
circuitry configured to:
acquire audio information and image information from an input source, generate character information indicating speech content of a speaker from the audio information using a speech recognition model, generate feature information indicating a facial expression state of the speaker from the image information using an image analysis model, and store the character information and the feature information in association with each other in a memory;
train a generative AI model using the character information and the feature information by applying a generative AI training technique, and configure the generative AI model to generate output text conditioned on speech patterns and facial expression states;
receive, via a communication interface coupled to a packet-switched network, a prompt sentence from a terminal device, the prompt sentence comprising instructions specifying a speaking style and a facial expression state, configure input information for the generative AI model based on the prompt sentence, and input the prompt sentence to the generative AI model to generate output text corresponding to the speaking style and the facial expression state; and
convert the output text into audio information using a speech synthesis technique and transmit the audio information to the terminal device via the communication interface.

2. The system according to claim 1, wherein the circuitry is configured to control a user interface provided on the terminal device to display the character information of the output text, present a visual response based on the feature information regarding the facial expression state associated with the output text, and receive a user operation comprising reproduction control.

3. The system according to claim 2, wherein the circuitry is configured to present, through the user interface, a human-like figure that produces synchronized visual and auditory responses by mapping the feature information to facial animation parameters and combining the facial animation parameters with the audio information.

4. The system according to claim 3, wherein the circuitry is configured to receive a user operation indicating a reproduction control command from the terminal device, and adjust a playback parameter of the audio information in response to the reproduction control command.

5. The system according to claim 4, wherein the circuitry is configured to record interaction history comprising user operations, audio information transmitted, and character information displayed during a session, and store the interaction history in the memory.

6. The system according to claim 1, wherein the circuitry is configured to perform content filtering on the output text by comparing the output text against predetermined expression constraint information, and remove or replace expressions that do not satisfy the expression constraint information prior to inputting the output text to the speech synthesis technique.

7. The system according to claim 1, wherein the generative AI model is trained using pairs of the character information and the feature information, wherein each pair associates a transcribed utterance with a corresponding facial expression state observed at the time of the utterance.

8. The system according to claim 7, wherein the image analysis model applies a convolutional neural network to the image information to extract the facial expression state as a multi-dimensional feature vector representing at least one of mouth configuration, eye configuration, and eyebrow configuration.

9. The system according to claim 1, wherein the speech recognition model applies an acoustic model and a language model to the audio information to generate the character information as a text sequence with associated confidence scores.

10. The system according to claim 1, wherein the circuitry is configured to acquire behavior history information of a user from the terminal device and store the behavior history information in the memory, analyze the behavior history information to derive preference information, and incorporate the preference information into the prompt sentence prior to inputting the prompt sentence to the generative AI model.

11. The system according to claim 10, wherein the circuitry is configured to classify and aggregate the behavior history information to extract preference category information, price range information, and attribute information of the user as the preference information, and dynamically generate an updated prompt sentence based on the preference information.

12. The system according to claim 11, wherein the circuitry is configured to instruct, through the updated prompt sentence, the generative AI model to generate a plurality of proposal items and personalized conversational text adapted to the preference information.

13. The system according to claim 1, wherein the prompt sentence comprises at least two of target attribute information, speaking style parameters, facial expression state specifications, and situational context information.

14. The system according to claim 1, wherein the speech synthesis technique applies a neural text-to-speech model to the output text to generate the audio information as a waveform with prosody parameters derived from the feature information.

15. The system according to claim 14, wherein the prosody parameters comprise at least one of pitch contour, speaking rate, and energy envelope associated with the facial expression state.

16. The system according to claim 1, wherein the circuitry is configured to standardize speech patterns and facial expression states by using the output text generated by the generative AI model and the audio information output by the speech synthesis technique to build a normalized reference corpus stored in the memory.

17. The system according to claim 16, wherein the circuitry is configured to compare newly generated output text against entries in the normalized reference corpus to compute a quality score, and regenerate the output text when the quality score falls below a predetermined threshold.

18. A system comprising:
circuitry configured to:
acquire audio information and image information, generate character information from the audio information using a speech recognition model, and generate feature information indicating a facial expression state from the image information using an image analysis model;
train a generative AI model using the character information and the feature information so that the generative AI model generates output text conditioned on speech patterns and facial expression states;
receive a prompt sentence via a communication interface, input the prompt sentence to the generative AI model to generate output text corresponding to the speaking style and the facial expression state specified in the prompt sentence; and
convert the output text into audio information using a speech synthesis technique and transmit the audio information to a terminal device via the communication interface, and present a synchronized visual and auditory response on the terminal device based on the feature information and the audio information.

19. The system according to claim 18, wherein the circuitry is configured to acquire behavior history information from the terminal device, derive preference information from the behavior history information, and incorporate the preference information into the prompt sentence to instruct the generative AI model to generate output text adapted to the preference information.

20. A method comprising:
acquiring audio information and image information from an input source, generating character information indicating speech content of a speaker from the audio information using a speech recognition model, generating feature information indicating a facial expression state of the speaker from the image information using an image analysis model, and storing the character information and the feature information in association with each other in a memory;
training a generative AI model using the character information and the feature information by applying a generative AI training technique, and configuring the generative AI model to generate output text conditioned on speech patterns and facial expression states;
receiving, via a communication interface coupled to a packet-switched network, a prompt sentence from a terminal device, the prompt sentence comprising instructions specifying a speaking style and a facial expression state, configuring input information for the generative AI model based on the prompt sentence, and inputting the prompt sentence to the generative AI model to generate output text corresponding to the speaking style and the facial expression state; and
converting the output text into audio information using a speech synthesis technique and transmitting the audio information to the terminal device via the communication interface.
